(19) United States
(12) Patent Application Publication
(10) Pub. No.: US 2024/0368986 A1
(43) Pub. Date: Nov. 7, 2024

(54) METHOD TO IMAGE SMALL-SCALE VARIABILITY OF SUBSURFACE RESERVOIRS

(71) Applicant: KING FAHD UNIVERSITY OF PETROLEUM AND MINERALS, Dhahran (SA)

(72) Inventor: Ammar Mohammed ADAM, Dhahran (SA)

(73) Assignee: KING FAHD UNIVERSITY OF PETROLEUM AND MINERALS, Dhahran (SA)

(21) Appl. No.: 18/311,553

(22) Filed: May 3, 2023

(51) Int. Cl. E21B 49/08; G01V 1/50

(52) U.S. Cl. CPC E21B 49/087; G01V 1/50; E21B 2200/20; E21B 2200/22; G01V 2210/6244; G01V 2210/6246

(57) ABSTRACT

A method to image a subsurface reservoir and resolve intra-reservoir heterogeneities that includes obtaining a plurality of depth logs of porosity and permeability of the subsurface reservoir using depth logs are laterally spaced about 5 meters with porosity measured by a helium porosimeter and permeability measured by a hassler core holder assembly. A porosity model and a permeability model of the subsurface reservoir is formed based on the plurality of depth logs by applying Sequential Gaussian Simulation (SGS) to the porosity and permeability values of the depth logs. Identifying heterogeneities in the porosity and a permeability model of the subsurface reservoir. Porosity and permeability are measured radially to a cylindrical core sample by face-sealing and excluding axial transmission.

### BACKGROUND

### Technical Field

The present disclosure is directed to a method to image small-scale variability of subsurface reservoirs.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Optimal exploitation of hydrocarbon reservoirs depends on qualitative and quantitative geological characterization of the hydrocarbon reservoirs. The quantitative geological characterization of the hydrocarbon reservoirs includes identification of reservoir properties and its variability trend (for example, geobody architecture and microfacies characteristics, including porosity and permeability). These identified properties are integrated into three-dimensional (3D) geostatistical models. Reservoir development and production strategies may be dependent on the 3D geostatistical models. Therefore, it is imperative to accurately identify and obtain the geological and petrophysical nature of the hydrocarbon reservoirs. Conventional inter-well spacing is kept for about 5 km. This is because trends of variability less than 5 km may not be captured well. Even small-scales (meter-scale) variabilities may have a critical impact on fluid flow and hence can have a direct influence on the exploitation of the hydrocarbon reservoirs.

Accordingly, to enhance 3D geostructural models the present disclosure provides a method and system that provides detailed data through an outcrop-based method to capture small-scale reservoir properties and related variabilities. The resolution of 3D geostatistical models of the a hydrocarbon-containing subterranean reservoir can thereby be enhanced. In one aspect, around 500 outcrop sections (5-meter spacing) were logged from a sediment logical and petrophysical perspective as basis for forming a model.

### SUMMARY

In an exemplary embodiment, a method to image a subsurface reservoir and resolve intra-reservoir heterogeneities is disclosed. The method includes obtaining a plurality of depth logs of porosity and permeability of the subsurface reservoir. In an example, the depth logs are laterally spaced about 5 meters. In examples, the porosity of the lateral sections is measured by a helium porosimeter and the permeability of the lateral sections is measured by a hassler core holder assembly. The method further includes forming a porosity model and a permeability model of the subsurface reservoir based on the plurality of depth logs by applying Sequential Gaussian Simulation (SGS) to the porosity and permeability of the depths logs to identify heterogeneities in the porosity, and a permeability model of the subsurface reservoir.

In another exemplary embodiment, a non-transitory computer readable medium is disclosed. The non-transitory computer readable medium includes instructions stored therein that, when executed by one or more processors, cause the one or more processors to perform a method including obtaining a plurality of depth logs of porosity and permeability of the subsurface reservoir. The depth logs are laterally spaced about 5 meters, where the porosity of the lateral sections is measured by a helium porosimeter and the permeability of the lateral sections is measured by a hassler core holder assembly. The method further includes forming a porosity model and a permeability model of the subsurface reservoir based on the plurality of depth logs by applying SGS to the porosity and permeability of the depths logs to identify heterogeneities in the porosity.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary flowchart to image a subsurface reservoir and resolve intra-reservoir heterogeneities, according to certain embodiments.

FIG. 2A-FIG. 2D depict studied outcrops that are located in the Buraydah and Faydah quadrangles in central Saudi Arabia.

FIG. 3 depicts a representation of Khuff Formation in Ad Dawadimi quadrangle.

FIG. 4A-FIG. 4C depict zones and layers of high-frequency sequences, bed-sets, and bed level models respectively, according to certain embodiments.

FIG. 5A-FIG. 5E depict a sequence stratigraphic interpretation of Upper Khartam Member, according to certain embodiments.

FIGS. 6A(a-c) depict upscaled microfacies data for different stratigraphic bed level bed-set level, and high-frequency sequence level, respectively.

FIG. 6B depicts an example of upscaled cells in a bed and bed-set levels that are relatively close to original data set.

FIG. 7A-FIG. 7C depict a three-dimensional (3D) geocellular model of the Upper Khartam Member.

FIGS. 8A(a-c) and FIGS. 8B(a-c) depict histograms showing a comparison between measured and upscaled porosity and permeability.

FIG. 9A to FIG. 9H depict porosity variogram models of studied intra-reservoir bodies.

FIG. 10A to FIG. 10H depict permeability variogram models of the studied intra-reservoir bodies.

FIG. 11A-FIG. 11E depict a representation of a 3D geocellular model of porosity.

FIG. 12A-FIG. 12E depict a representation of a 3D geocellular model of permeability.

FIG. 13A depicts a representation of fracture corridors.

FIG. 13B depicts a representation of controlled influxes of diagenetic fluid.

FIG. 13C depicts a representation of controlled influxes of diagenetic fluid that are reflected in variability patterns in variogram.

FIG. 14 depicts a representation of data resolution, scale of variabilities and controlling factors, and information on the present disclosure to enhance 3D reservoir models.

FIG. 15 is an illustration of a non-limiting example of details of computing hardware used in the computing system.

FIG. 16 is an exemplary schematic diagram of a data processing system used within the computing system.

FIG. 17 is an exemplary schematic diagram of a processor used with the computing system.

FIG. 18 is an illustration of a non-limiting example of distributed components which may share processing with the controller.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a method to image small-scale variability of subsurface reservoirs. According to aspects of the present disclosure, small-scale spatial distribution of microfacies, geobody architecture, and variability trends of porosity were analyzed. Further, permeability of hydrocarbon-containing carbonate rock formations such as the Khuff carbonates in some of outcrop localities in central Saudi Arabia were investigated. An outcrop is a visible exposure of bedrock. Around 500 vertical outcrop sections were logged in detail from the sediment logical and petrophysical point of view, and about 500 samples were collected for petrographic and petrophysical analysis. The vertical outcrop sections have a lateral spacing of 5 meters, and they cover an area of about 750 meters by 450 meters.

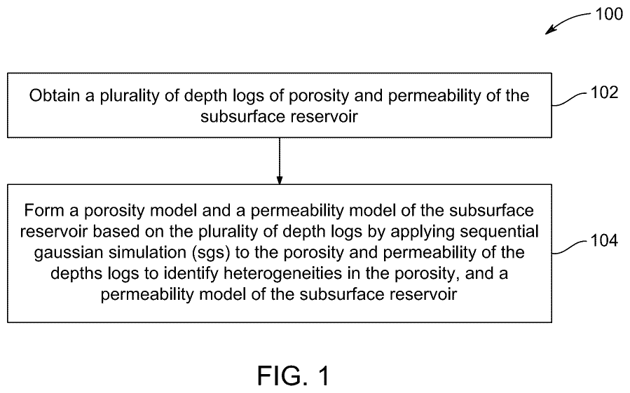

FIG. 1 illustrates an exemplary flowchart 100 to image a subsurface reservoir and resolve intra-reservoir heterogeneities, according to certain embodiments.

At step 102 of the flowchart 100, a plurality of depth logs of porosity and permeability of the subsurface reservoir is obtained. In an example, the depth logs are laterally spaced about 5 meters, where the porosity of lateral sections is measured by a helium porosimeter (for example the Advanced Helium Porosimeter from Porous materials Inc. of 20 Dutch Mill Rd, Ithaca, NY 14850, USA using a max. core diameter: of 1.5 inch, a max core length: of 2.5 inch, and calibrated to NIST test #821/25B 592-97 performed in accordance with requirements of ANSI/NSCL 2640-1-94 and ISO 10012-1-92) and the permeability of the lateral sections is measured by a hassler core holder assembly (for example, the RCH Core Holder from Core Lab Inc. of 4616 North Mingo, Tulsa, OK 74117 USA).

At step 104 of the flowchart 100, a porosity model and a permeability model of the subsurface reservoir may be formed based on the plurality of depth logs by applying Sequential Gaussian Simulation (SGS) to the porosity and permeability of the depths logs to identify heterogeneities in the porosity (see for example Ortiz, J M, “Introduction to sequential Gaussian simulation, Predictive Geometallurgy and Geostatistics Lab”, Queen's University, Annual Report 2020, paper 2020-01, 7-19—incorporated herein by reference in its entirety).

In a preferred embodiment of the invention porosity and permeability values are limited such that fluid these values represent only lateral fluid transmission within subsurface geological strata and exclude horizontally fluid between strata. In this aspect of the present disclosure, porosity and permeability are measured on cylindrical core samples that are face-sealed such that there no axial fluid transmission occurs between first and second ends of the core sample. To ensure complete face sealing and elimination of gaseous or liquid axial transport through a core sample, each face (flat end) of the core sample is first cut or polished to provide a flat end surface (face) that is substantially perpendicular to the axis of the core sample. Subsequently, a composition containing a curable (polymerizable) monomer and a corresponding polymerization catalyst is applied at both ends of the core sample. The monomer-containing composition preferably penetrates pores, cavities and vacancies at both faces of the core sample prior to polymerization and curing. Penetration of the monomer composition to a depth of as much as 1 mm into the each face of the core sample and subsequent curing of the monomer ensures that no axial transport of gaseous or liquid fluid occurs during measurement of permeability or porosity. An epoxy resin in combination with a polyamine polymerization catalyst may be used for sealing the faces of the core sample. Core samples are obtained by drilling into the the subsurface formation.

The porosity model and the permeability model of the subsurface reservoir may be used in forming a three-dimensional (3D) geostatistical model. The 3D geostatistical model may be configured to accommodate a display between 300 to 500 outcrops. Further, the 3D geostatistical model includes data to resolve intra-reservoir heterogeneities.

In an implementation, a petrophysical model may be created by applying the SGS to the analyzed porosity and permeability trends through spherical model types. Variogram models and maps of porosity from the SGS may be fitted to the analyzed porosity and permeability trends. In an example, the petrophysical model may have a spacing interval between 5 meters and 25 meters.

In some implementations, a microfacies model may be created by assigning values for each microfacies type of the lateral sections on a bed level, a bed-set level, a fifth-order sequence level, and a fourth-order sequence level. Further, the microfacies at the bed-set level may be modeled with a Sequential Indicator Simulation (SIS) from the assigned values and architectural elements of the lateral sections. In an example, the microfacies type represents at least seven depositional settings. In examples, the seven depositional settings include intertidal-subtidal flats, intertidal channels and creeks, shoal ridges, reef complex, outer ramp settings, and supratidal settings. In an example, the intertidal channels have a porosity between 300 meters and 400 meters. Further, in an example, the intertidal-subtidal flats have a porosity between 100 meters and 200 meters.

In an implementation, the SIS model includes sheet-like beds that vary in thickness between 5 meters to 50 meters. In an example, the SIS model has a lateral extension value between 5 meters to 300 meters. In some examples, the SIS model has horizontal variograms that range from 50 meters to 1000 meters. The modeling microfacies with the SIS model further comprises diving the architectural elements of the lateral.

In central Saudi Arabia, the Upper Khartam Member is exposed in several locations. However, the studied outcrops are located in the Buraydah and Faydah quadrangles in central Saudi Arabia. Around 500 vertical outcrop sections were logged in detail from a sediment logical and petrophysical point of view. The vertical outcrop sections have a lateral spacing of 5 meters. Further, the vertical outcrop sections cover an area of 750 meters by 450 meters. The depth-logs are based on a bed-by-bed field description, and approximately 600 samples were collected for detailed petrographic and petrophysical analysis. Furthermore, nine intra-reservoir bodies were logged laterally for porosity and permeability. The examined intra-reservoir bodies were selected to represent the reservoir geology observed in the studied outcrops, and they include FZ-B12B, FZ-B14C, FZ-B15B, FZ-B20B, FZ-B9B, FZ-B10A, FZ-B11C, FZ-B12C, and FZ-B13C of Adam et al. (2018) (See: Adam et al. “Reservoir heterogeneity and quality of Khuff carbonates in outcrops of central Saudi Arabia”, 2018. March Pet. Geol. 89, 721-751—incorporated herein by reference in its entirety). Core plugs are mostly horizontally oriented and of size 2 inches by 1 inch in length and diameter, respectively. Porosity was measured using the helium porosimeter, while liquid (nitrogen) permeability was obtained from gas permeability and verification of the Klinkenberg effect using the hassler core holder assembly. In examples, Petrel software is used to recover the stratal stacking patterns and to analyze variability trends in porosity and permeability. In an implementation, three stratigraphic levels of Adam et al. (2020) were modeled (See: Adam et al., 2020, “High-frequency sequence stratigraphy of the Early Triassic Khuff carbonates in outcrops of central Saudi Arabia: assessment of reservoir architecture”, Journal of Petroleum Geology). The three stratigraphic levels include the newly established fifth-order sequences level, bed-sets level, and bed levels. The three stratigraphic levels have cell numbers 75336 (146×86×7), 213452 (146×86×18), and 2837656 (146×86×226), respectively.

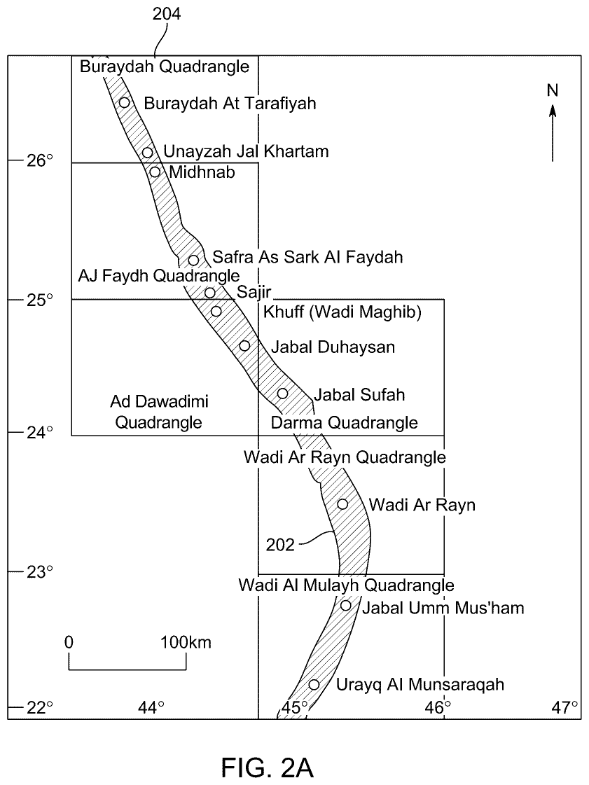

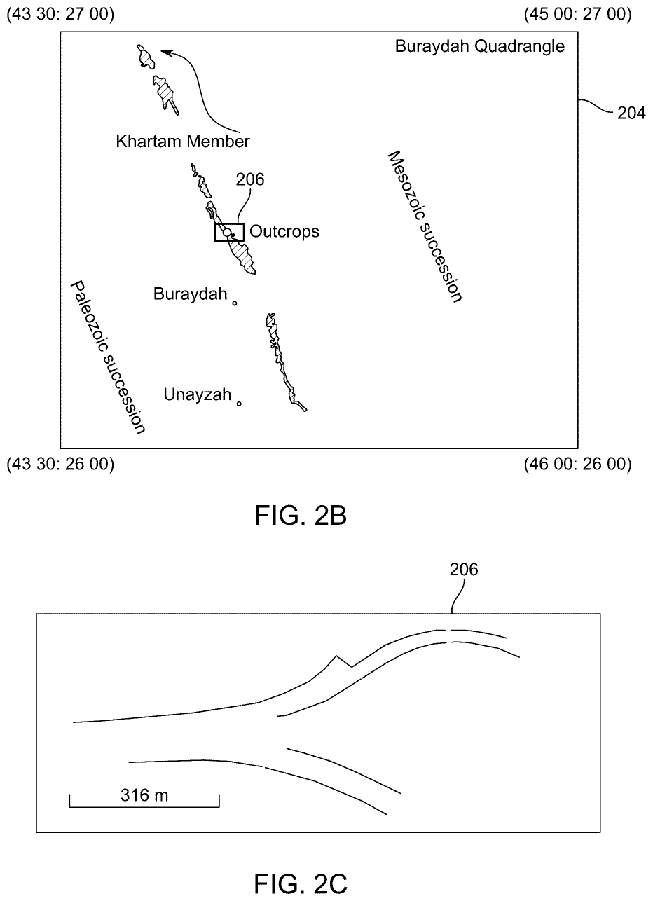

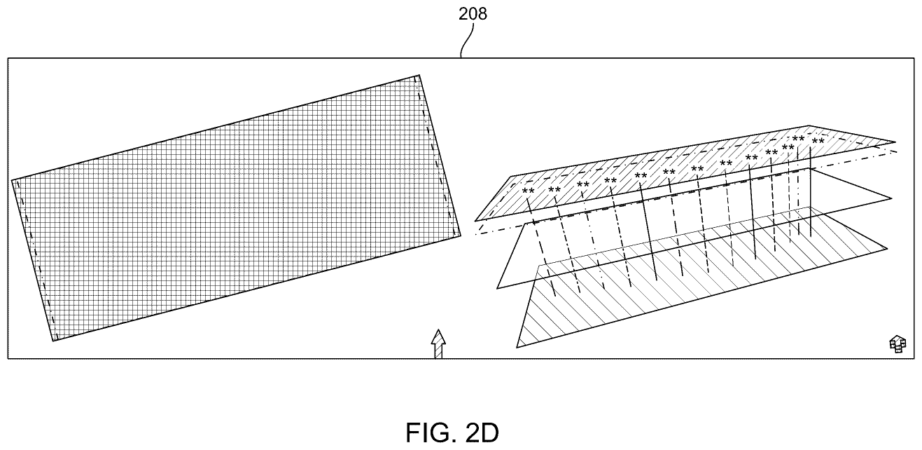

FIG. 2A-FIG. 2D depict studied outcrops that are located in the Buraydah and Faydah quadrangles in central Saudi Arabia. In particular, FIG. 2A depicts Khuff outcrop formation belt in central Saudi Arabia (represented by reference numeral “202”). The Buraydah quadrangle represented by reference numeral “204” in FIG. 2A. FIG. 2B depicts the Buraydah quadrangle in detail. In an example, FIG. 2B depicts Upper Khartam Member outcrops in the Buraydah quadrangle (represented by reference numeral “206”). FIG. 2C depicts the studied outcrops located in the Buraydah quadrangle. FIG. 2D depicts pillar gridding of the study area (represented by reference numeral “208”). The study area is oriented in a north-east direction with symmetrical cell sizes in horizontal directions (where the spacing of the vertical outcrop sections is 5 meters by 5 meters), while vertical resolution covers the modelled stratigraphic levels (6, 14, and 226 layers for high-frequency sequences, bed-sets levels, and bed level modelling respectively of Adam et al. (2020).

In an example, the boundaries of the high-frequency sequences and the bed-sets levels are used for zonation processes while layering architecture is based on the characteristics of the beds within bed-sets. The modeling parameters are described in Table 1 and Table 2 provided below. For ease of representation, the high-frequency sequences are abbreviated to HFS, the bed-sets is abbreviated to BS, and Microfacies Types are abbreviated to MFT in Tables 1 and 2.

TABLE 1
Summary of the modeling parameters of the high-
frequency sequences and the bed-set levels

| Strati- | | | | | Petrophysical parameters | | | | |
|---|---|---|---|---|---|---|---|---|---|
| graphic | | Top | Microfacies | | Phi | K | Phi | K | Modeling |
| level | Zone | surface | Types | Code | (mean) | (mean) | (core) | (core) | method |
| HFS | HFS6 | FS-S7 | Bioclastic | MFT6 | 0.33 | 20125 | 0.12 | 31.74 | Assign |
| modeling | | | grainstone/ | | | | | | value |
| | | | packstone | | | | | | |
| | HFS5 | FS-S6 | Bioclastic | MFT6 | 0.36 | 31667 | 0.09 | 4.40 | Assign |
| | | | grainstone/ | | | | | | value |
| | | | packstone | | | | | | |
| | HFS4 | FS-S5 | Coarse- | MFT1 | 0.36 | 49125 | 0.13 | 3.47 | Assign |
| | | | grained | | | | | | value |
| | | | oolitic | | | | | | |
| | | | grainstone | | | | | | |
| | HFS3 | FS-S4 | Recrystal- | MFT3 | 0.40 | 51275 | 0.08 | 0.66 | Assign |
| | | | lized | | | | | | value |
| | | | limestone | | | | | | |
| | HFS2 | FS-S3 | Coarse- | MFT1 | 0.19 | 18781 | 0.12 | 0.33 | Assign |
| | | | grained | | | | | | value |
| | | | oolitic | | | | | | |
| | | | grainstone | | | | | | |
| | HFS1 | RS-S2 | Coarse- | MFT1 | 0.20 | 16100 | 0.06 | 10.80 | Assign |
| | | | grained | | | | | | value |
| | | | oolitic | | | | | | |
| | | | grainstone | | | | | | |
| Bed-set | BS14 | FS-S7 | Bioclastic | MFT6 | 0.23 | 21292 | 0.12 | 35.20 | Assign |
| modeling | | | grainstone/ | | | | | | value |
| | | | packstone | | | | | | |
| | BS13 | BS13/ | Bioclastic | MFT6 | 0.41 | 15500 | 0.14 | 52.10 | Assign |
| | | BS14 | grainstone/ | | | | | | value |
| | | | packstone | | | | | | |
| | BS12 | FS-S6 | Coarse- | MFT1 | 0.34 | 23583 | 0.10 | 7.91 | Assign |
| | | | grained | | | | | | value |
| | | | oolitic | | | | | | |
| | | | grainstone | | | | | | |
| | BS11 | BS11/ | Thin-walled | MFT17 | 0.33 | 25333 | 0.14 | 8.42 | Assign |
| | | BS12 | bivalve | | | | | | value |
| | | | rudstone | | | | | | |
| | BS10 | FS-S5 | Coarse- | MFT1 | 0.40 | 38000 | 0.05 | 0.38 | Assign |
| | (2) | | grained | | | | | | value |
| | | | oolitic | | | | | | |
| | | | grainstone | | | | | | |
| | FZ- | Top | Bioclastic | MFT6 | 0.32 | 90000 | 0.26 | 4.74 | Assign |
| | B20B | B20B | grainstone/ | | | | | | value/ |
| | | | packstone | | | | | | SGS |
| | BS10 | Bottom | Coarse- | MFT1 | 0.38 | 62750 | 0.14 | 2.50 | Assign |
| | (1) | B20B | grained | | | | | | value |
| | | | oolitic | | | | | | |
| | | | grainstone | | | | | | |
| | BS9 | BS9/ | Bioclastic | MFT6 | 0.40 | 47000 | 0.12 | 0.34 | Assign |
| | | BS10 | grainstone/ | | | | | | value |
| | | | packstone | | | | | | |
| | BS8 | FS-S4 | Oolitic | MFT12 | 0.37 | 175000 | 0.17 | 0.83 | Assign |
| | (2) | | grainstone/ | | | | | | value |
| | | | grapestone | | | | | | |
| | FZ- | Top | Coarse- | MFT1 | 0.40 | 30000 | 0.02 | 0.07 | Assign |
| | B15B | B15B | grained | | | | | | value/ |
| | | | oolitic | | | | | | SGS |
| | | | grainstone | | | | | | |
| | FZ- | BS7/ | Coarse- | MFT1 | 0.40 | 30000 | 0.02 | 0.03 | Assign |
| | B14C | BS8 | grained | | | | | | value/ |
| | | | oolitic | | | | | | SGS |
| | | | grainstone | | | | | | |
| | BS7 | Bottom | Recrystal- | MFT3 | 0.40 | 20000 | 0.11 | 1.61 | Assign |
| | (1) | B14C | lized | | | | | | value |
| | | | limestone | | | | | | |
| | BS6 | BS6/ | Recrystal- | MFT3 | 0.41 | 1375 | 0.09 | 0.76 | Assign |
| | | BS7 | lized | | | | | | value |
| | | | limestone | | | | | | |
| | FZ- | FS-S3 | Coarse- | MFT1 | 0.34 | 50000 | 0.31 | 0.57 | Assign |
| | B12B | | grained | | | | | | value/ |
| | | | oolitic | | | | | | SGS |
| | | | grainstone | | | | | | |
| | BS5 | Bottom | marlstone | MFT7 | 0.00 | 0 | 0.00 | 0.00 | Assign |
| | (1) | B12B | | | | | | | value |
| | BS4 | BS4/ | Fine- | MFT5 | 0.22 | 6344 | 0.05 | 0.41 | Assign |
| | | BS5 | grained | | | | | | value |
| | | | oolitic | | | | | | |
| | | | grainstone | | | | | | |
| | HFS1 | RS-S2 | Coarse- | MFT1 | 0.20 | 16100 | 0.06 | 10.80 | Assign |
| | | | grained | | | | | | value |
| | | | oolitic | | | | | | |
| | | | grainstone | | | | | | |

TABLE 2
Summary of the modeling parameters of the bed level.

| | | | Total | Architec- | | Layers | | |
|---|---|---|---|---|---|---|---|---|
| High- | | | thick- | tural | Dimen- | thick- | | |
| frequency | Bed- | Microfacies | ness | character- | sions | ness | Layers | Modelling |
| sequences | sets | Types | (cm) | istics | (m) | (cm) | number | method |
| HFS1 | BS1 | MFT 10 | 20 | Sheet- | 50 by | 10 | 2 | SIS |
| | | | | like | 1000 | | | |
| | | | | bodies | | | | |
| | BS2 | MFT 1, MFT 7 | 50 | Sheet- | 50 by | 10 | 5 | SIS |
| | | | | like | 1000 | | | |
| | | | | bodies | | | | |
| | BS3 | MFT 1, MFT 7 | 50 | Sheet- | 50 by | 10 | 5 | SIS |
| | | | | like | 1000 | | | |
| | | | | bodies | | | | |
| HFS2 | BS4 | MFT 6, MFT | 300 | Sheet- | 50 by | 10 | 30 | SIS |
| | | 2, MFT 3, | | like | 1000 | | | |
| | | MFT 5, MFT 1 | | bodies | | | | |
| | BS5 | MFT 1, MFT 7 | 250 | Small | 250 | 30 | 10 | SIS |
| | | | | tidal | | | | |
| | | | | creeks | | | | |
| HFS3 | BS6 | MFT 3, MFT | 213 | Sheet- | 50 by | 10 | 10 | SIS |
| | | 5, MFT 7 | | like | 1000 | | | |
| | | | | bodies | | | | |
| | BS7 | MFT 3, MFT | 370 | Sheet- | 75 by | 15 | 12 | SIS |
| | | 5, MFT 7 | | like | 1500 | | | |
| | | | | bodies | | | | |
| | BS8 | MFT 1, FT11, | 450 | Large | 500 | 50 | 9 | SIS |
| | | MFT 7, MFT | | tidal | | | | |
| | | 12 | | channels | | | | |
| HFS4 | BS9 | MFT 6, MFT | 356 | Sheet- | 50 by | 10 | 35 | SIS |
| | | 8, MFT 1 | | like | 10000 | | | |
| | | | | bodies | | | | |
| | BS10 | MFT 1, MFT | 414 | Sheet- | 250 by | 50 | 8 | SIS |
| | | 13, MFT 8, | | like | 5000 | | | |
| | | MFT 6, MFT | | bodies | | | | |
| | | 14 | | | | | | |
| HFS5 | BS11 | MFT 8, MFT | 114 | Sheet- | 50 by | 10 | 10 | SIS |
| | | 1, MFT 17, | | like | 1000 | | | |
| | | MFT 7 | | bodies | | | | |
| | BS12 | MFT 8, MFT 1 | 187 | Sheet- | 100 by | 20 | 9 | SIS |
| | | | | like | 2000 | | | |
| | | | | bodies | | | | |
| HFS6 | BS13 | MFT 1, MFT 9 | 150 | Sheet- | 50 by | 10 | 15 | SIS |
| | | | | like | 1000 | | | |
| | | | | bodies | | | | |
| | BS14 | MFT 17, MFT | 169 | Sheet- | 100 by | 20 | 8 | SIS |
| | | 14, MFT 6, | | like | 2000 | | | |
| | | MFT 9, MFT | | bodies | | | | |
| | | 7, MFT 16 | | | | | | |

In the example shown above, BS4 is about 300 centimeters thick and composed of sheet-like bodies formed in an intertidal setting. Beds within BS4 are of 10 centimeters thick. Accordingly, a layer thickness of 10 centimeters was chosen to subdivide BS4 into thin layers.

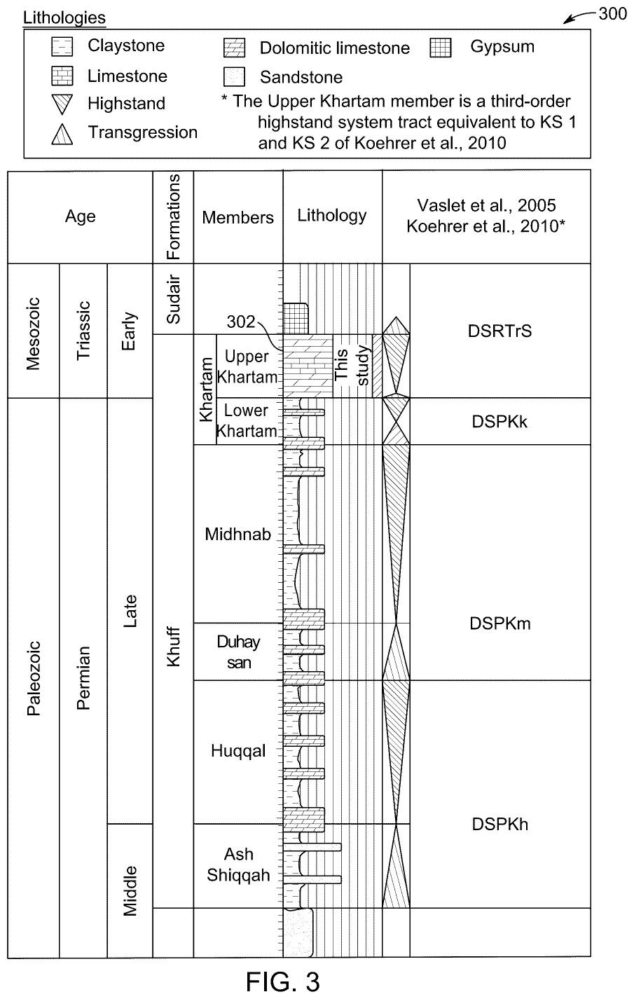

FIG. 3 depicts a representation 300 of Khuff Formation in the Ad Dawadimi quadrangle. In the Ad Dawadimi quadrangle, five members of the Khuff Formation are recognized. The studied section of the Upper Khartam Member is represented by reference numeral “302” in FIG. 3.

In an implementation, the Upper Khartam Member is composed of seventeen microfacies types, with oolitic grainstone and recrystallized limestone making up the bulk of the successions, as described in Table 3 provided below. The seventeen microfacies represent seven depositional settings including intertidal-subtidal flats, intertidal channels and creeks, shoal ridges, reef complex, outer ramp settings, and supratidal settings. Further, four hierarchical stratigraphic identities were defined including beds, bed-sets, high-frequency fifth-order sequence levels, and fourth-order sequences levels, according to Adam et al. (2018). In examples, the fifth-order sequences levels are related to Milankovitch cycles (eccentricity=100.000 years), and they are comparable to the Middle Triassic Muschelkalk small-scale cycles of Aigner et al. (1999) (See: Aigner et al., 1999, “Base level cycles in the Triassic of the South-German Basin: a short progress report”, Zentralblatt fur Geol. und Paleontologie 1 (7-8)) and Koebrer et al. (2010b) (See: Koehrer et al., 2010b “Multiple-scale facies and reservoir quality variations within a dolomite body—Outcrop analog study” from the Middle Triassic, SW German Basin. March Pet. Geol. 27, 386-411, each incorporated by reference).

TABLE 3
Summary of the Upper Khartam geology

| | Components and | | |
|---|---|---|---|
| | sedimentary | | Depositional |
| Microfacies Type | structures | Geobodies | settings |
| MFT 1: Coarse- | Coarse-grained, well- | Channel-like bodies | Intertidal |
| grained oolitic | rounded, well-sorted, | (3 m width and 50 cm | channels to |
| grainstone | cross-laminated | thick), sheet-like | intertidal |
| (MFA: 25.8%; MFQ: | oolitic grainstone | bodies, lateral extent | settings |
| 39.5%) | | vary between 5 m to | |
| | | several hundreds of | |
| | | meters | |
| MFT 2: | Horizontally to cross- | Sheet-like bodies, the | Intertidal to |
| Interlaminated quartz- | laminated | length ranges from 5 | intertidal creeks |
| bearing recrystallized | recrystallized | to 100 m, sparse of | |
| limestone | carbonates, | channel-like bodies, | |
| (MFA: 12.4%; MFQ: | abundances of quartz | width 1 m, thickness | |
| 13.8%) | lamina | 20 cm | |
| MFT 3: | Horizontally | Sheet-like bodies | Intertidal, |
| Recrystallized | laminated | (length 5-100 s m), | subtidal, |
| limestone | recrystallized | symmetrical wavy | intertidal creeks |
| (MFA: 7.7%; MFQ: | carbonates | geometry, | |
| 8.9%) | | channelized-bodies | |
| | | (15 cm thick, 20 cm | |
| | | width) | |
| MFT 4: | Fine-grained, well- | Relatively uniform, | Intertidal to |
| Interlaminated quartz- | rounded, well-sorted, | flat, horizontal, and | subtidal settings |
| bearing and fine- | horizontally and | continuous sheet-like | |
| grained oolitic | cross-laminated | bodies, ranging from | |
| grainstone | oolitic grainstone, an | 50 to 150 m | |
| (MFA: 2.7%; MFQ: | abundance of quartz | | |
| 7.1%) | grains | | |
| MFT 5: Fine-grained | Fine-grained, well- | Uniform, horizontal, | Intertidal to |
| oolitic grainstone | rounded, well-sorted, | and continuous sheet- | subtidal settings |
| (MFA: 4.6%; MFQ: | horizontally and | like bodies extending | |
| 5.9%) | cross-laminated | for about 100 m | |
| | oolitic grainstone | | |
| MFT 6: Bioclastic | Cross-laminated | Sheet-like bodies, | Intertidal to |
| grainstone-packstone | bivalve grainstone to | ranging in length | subtidal settings |
| (MFA: 3.1%; MFQ: | packstone | from 50 to 200 m | |
| 4.4%) | | | |
| MFT 7: Marlstone | Thinly laminated | Intermittent thin- | Supratidal flats |
| | marlstone | sheets | |
| MFT 8: Bioclastic | Thinly laminated | Uniform, horizontal, | Outer-ramp |
| wackestone-mudstone | ostracod wackestone | and continuous sheet- | settings |
| (MFA: 20.4%; MF: | to mudstone | like, ranging from 5 | |
| 3.0%) | | m to several hundreds | |
| | | of meters | |
| MFT 9: Non-fabric | Horizontally | Uniform, flat, sheet- | Intertidal to |
| preserved dolomite | laminated to cross- | like bodies, ranging | subtidal flats |
| (FA: 3.1%; FQ: | laminated dolomite | in length from 5 m to | |
| 2.8%) | | several hundreds of | |
| | | meters | |
| MFT 10: Calcareous | Thinly laminated to | Sheet-like bodies | Intertidal to |
| sandstone | cross-laminated | | subtidal flats |
| (MFA: 5.3%; MFQ: | calcareous sandstone | | |
| 2.7%) | | | |
| MFT 11: | Crinkled laminated | Intermittent, occur in | Intertidal |
| Microbialites build- | stromatolites and | amalgamation with | settings |
| ups | thrombolites | the sheet-like bodies | |
| (MFA: 1.5%; MFQ: | | | |
| 2.1%) | | | |
| MFT 12: Oolitic | Moderately to well- | Convex geometry | Shoal ridges |
| grainstone-grapestone | rounded, high angle | | complex |
| (MFA: 0.4%; MFQ: | cross-laminated | | |
| 2.1%) | oolitic grapestone | | |
| MFT 13: Mudstone | Thinly laminated | Flat, uniform, and | Outer-ramp |
| (MFA: 3.5%; MFQ: | mudstone | continuous sheet-like | |
| 1.6%) | | bodies ranging from | |
| | | 20 to 100 m laterally | |
| MFT 14: Peloidal | Well-sorted, well- | Uniform, horizontal, | Subtidal settings |
| grainstone-packstone | rounded, horizontally | and continuous sheet- | |
| (MFA: 1.5%; MFQ: | laminated peloidal | like bodies ranging in | |
| 1.4%) | grainstone to | length from 5 to 200 | |
| | packstone | m | |
| MFT 15: Skolithos | Poorly-sorted, | Limited lateral | Intertidal flats |
| bioclastic oolitic | intensively | exposure, horizontal | |
| grainstone | bioturbated | sheet-like bodies | |
| (MFA: 0.4%; MFQ: | (skolithos) oolitic | | |
| 0.8%) | grainstone | | |
| MFT 16: Gypsiferous | Gypsiferous claystone | Thin-seams | Supratidal flats |
| claystone | | | |
| (MFA: 3.5%; MFQ: | | | |
| 0.5%) | | | |
| MFT 17: Thin-walled | Crinkled laminated, | Occurs as sheet-like | Intertidal reef |
| bivalval rudstone | thin-walled bivalves | bodies ranging in | complex |
| (MFA: 0.8%; MFQ: | rudstone | length from 5 m to | |
| 0.5%) | | several hundreds of | |
| | | meters | |

For ease of representation, Microfacies Types is abbreviated to MFT, Microfacies Abundancy is abbreviated to MFA, and Microfacies Quantity is abbreviated to MFQ in Table 3. Further, MFA=((number of beds of the microfacies/total bed numbers)*100) and MFQ=((thickness of beds of the microfacies/total thickness)*100).

The stratigraphic analysis by Adam et al. (2020) revealed the critical similarity between the Upper Khartam and Khuff reservoirs. The Khuff reservoirs similarity was induced by the progradational nature of the carbonates and included microfacies types and stratal stacking patterns. For instance, throughout a regression phase (i.e., a fifth-order sequence level), sedimentary bodies of similar microfacies types and architectural elements tend to be deposited at different positions within the similar sequences (basin-ward shifted facies).

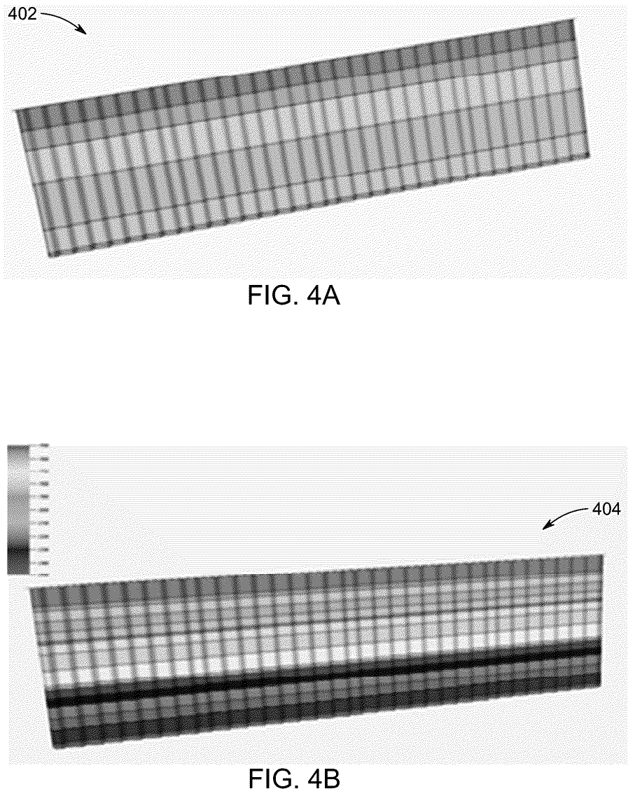

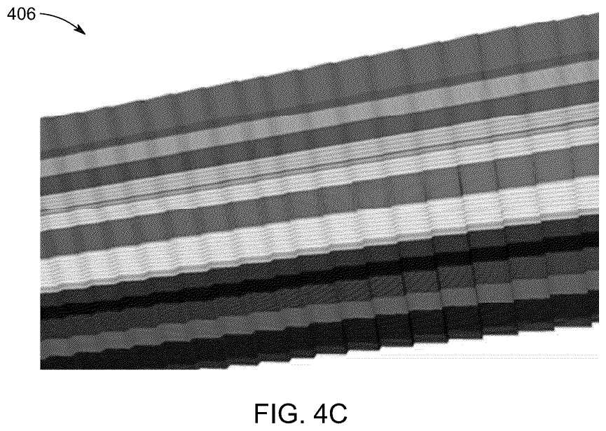

FIG. 4A-FIG. 4C depict zones and layers of high-frequency sequences, bed-sets, and bed level models respectively, according to certain embodiments. In particular, FIG. 4A depicts a representation 402 of zones and layers of high-frequency sequences model. FIG. 4B depicts a representation 404 of zones and layers of bed-set model. FIG. 4C depicts a representation 406 of zones and layers of bed level model.

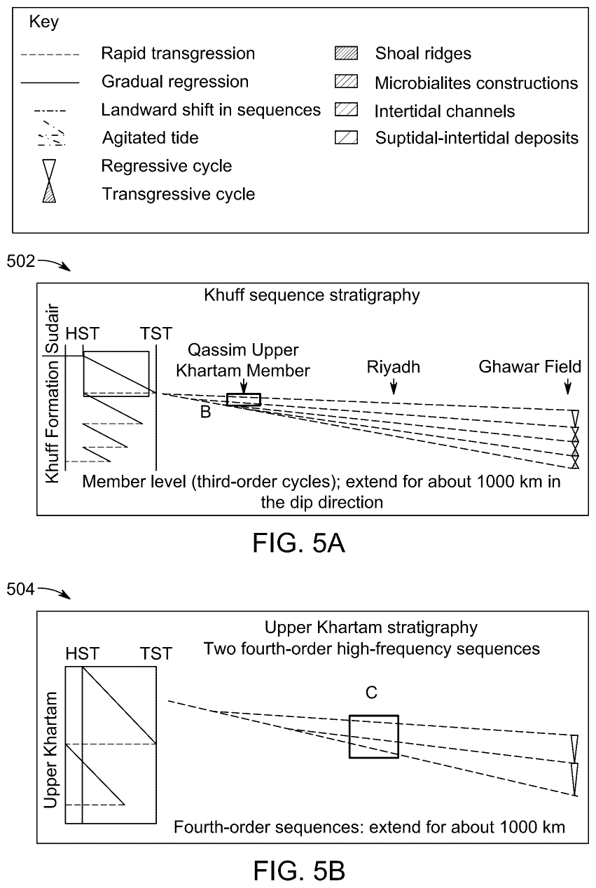

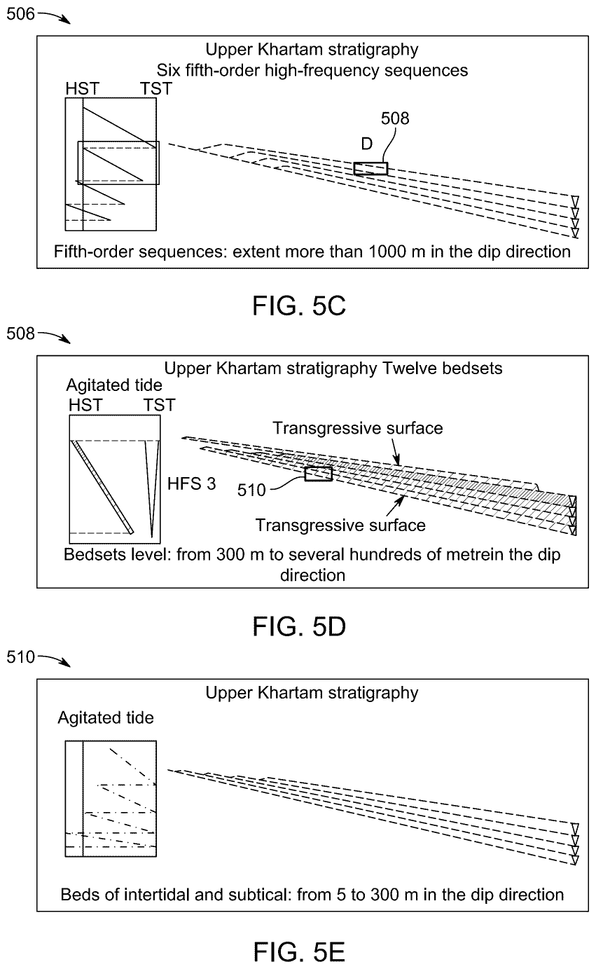

FIG. 5A-FIG. 5E depict sequence stratigraphic interpretation of the Upper Khartam Member, according to certain embodiments. FIG. 5A depicts a representation 502 of the Member span in age for about 1.25 Ma and extends laterally for 1000 kilometers in a dip direction. Fourth-order sequences of Qassim Upper Khartam Member that extend for shorter distances are represented by reference numeral “504” in FIG. 5A. FIG. 5B depicts the fourth-order sequences of Qassim Upper Khartam Member in greater detail. Fifth-order sequences that extend for shorter distances are represented by reference numeral “506” in FIG. 5B. FIG. 5C depicts the fifth-order sequences in greater detail. FIG. 5C depicts bed-sets levels that extend from 300 meters to several hundreds of meters in the dip direction (represented by reference numeral “508”). The bed-sets level corresponds to the typical internal makeup of single high-frequency sequences. The high-frequency sequences are typically composed from bottom to top, i.e., subtidal-intertidal deposits, intertidal channels, mirabilites, and caped by shoal ridges. FIG. 5D represents bed-sets level in greater detail. FIG. 5D also depicts beds of intertidal-subtidal flats that extend from 5 meters to 300 meters in the dip direction (represented by reference numeral “510”. FIG. 5E depicts the beds of intertidal-subtidal flats in greater detail. In examples, the mentioned lateral extension is for a single stratigraphic body. However, this stratigraphic body possesses a genetic relationship with a laterally amalgamated set of bodies. Mostly, the fifth-order sequences are likely illustrated by regressive cycles dominated by regressive deposits followed by pulses of transgressions. This nature is probably identical for the Upper Khartam carbonates (third-order sequence).

The microfacies models at the high-frequency sequences and bed-set levels were established directly by assigning values from the upscaled microfacies types. Although the method is straightforward, however, it is appropriate since the detailed lateral sediment logical analysis of bed-sets indicated little change in microfacies types at a lateral distance of 1000 meter in dip direction. The upscaled microfacies data at the bed-set level shows a good correlation with the original data (i.e., the bed-by-bed field description and microfacies analysis). In contrast, noticeable distortion in the upscaled microfacies data is observed in the high-frequency sequence level.

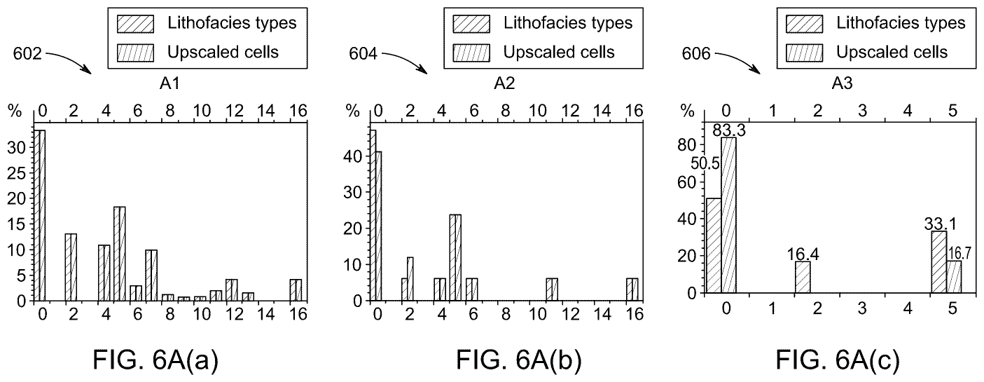

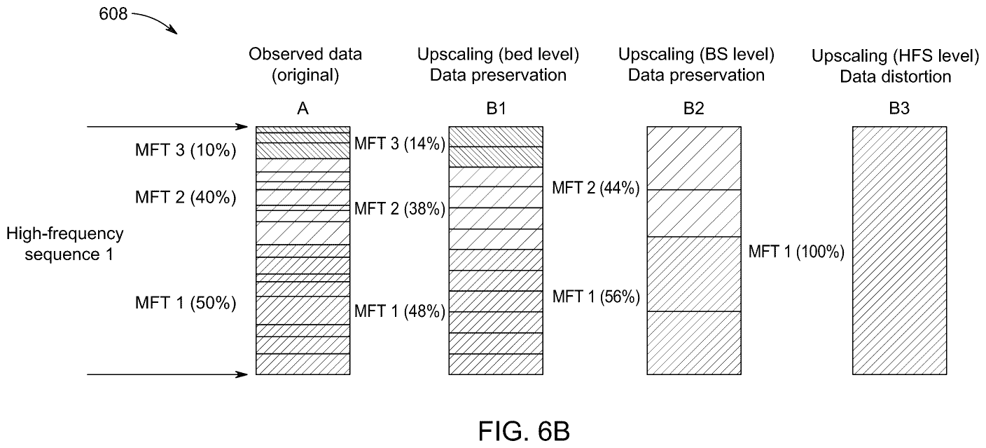

FIGS. 6A(a-c) depict upscaled microfacies data for different stratigraphic bed level bed-set level, and high-frequency sequence level, respectively. In particular, FIG. 6A(a) depicts a representation 602 of the upscaled microfacies data for the different stratigraphic bed level. FIG. 6A(b) depicts a representation 604 of the upscaled microfacies data for different bed-set level. FIG. 6A(c) depicts a representation 606 of the upscaled microfacies data for different high-frequency sequence level.

FIG. 6B depicts an example 608 of upscaled cells in the bed and bed-set levels that are relatively close to the original data set. It can be observed in FIG. 6B, noticeable distortion in the high-frequency sequence level.

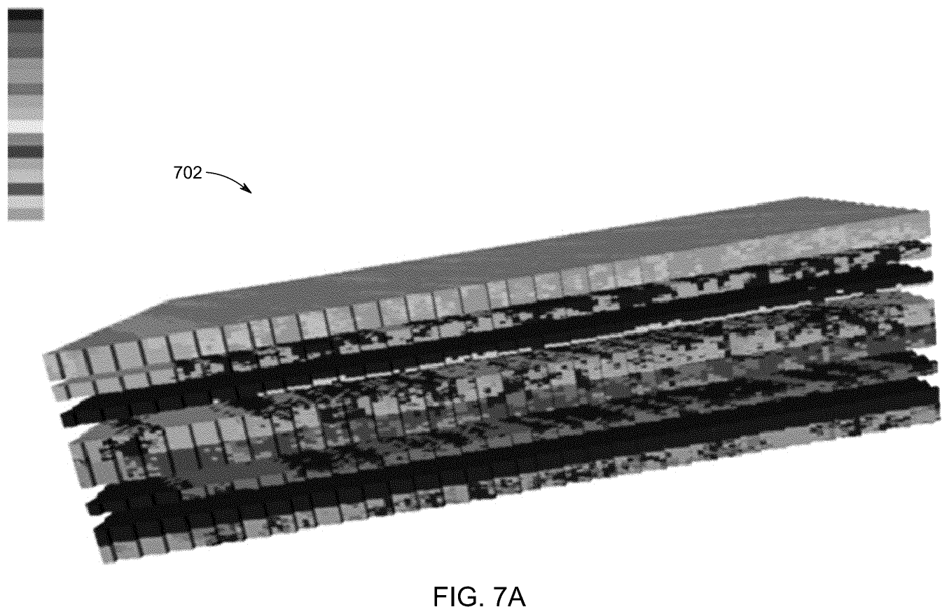

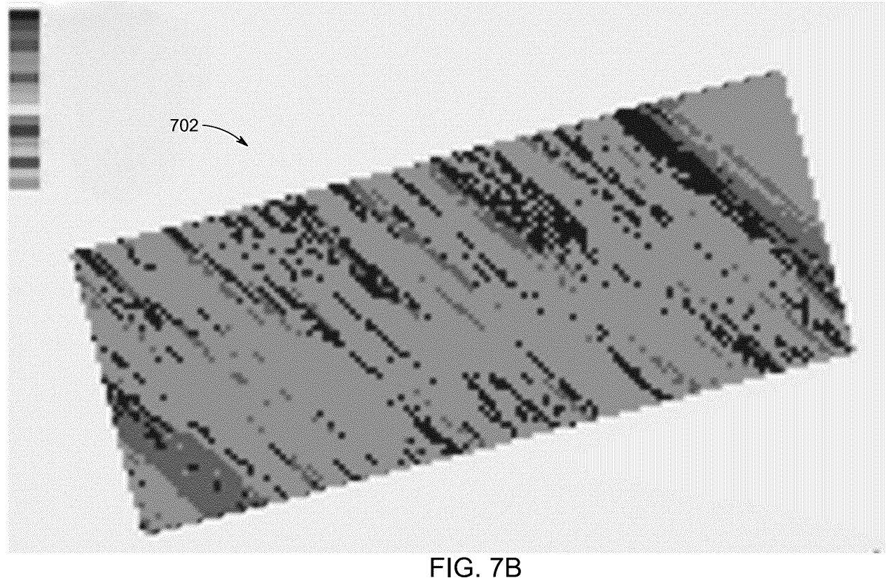

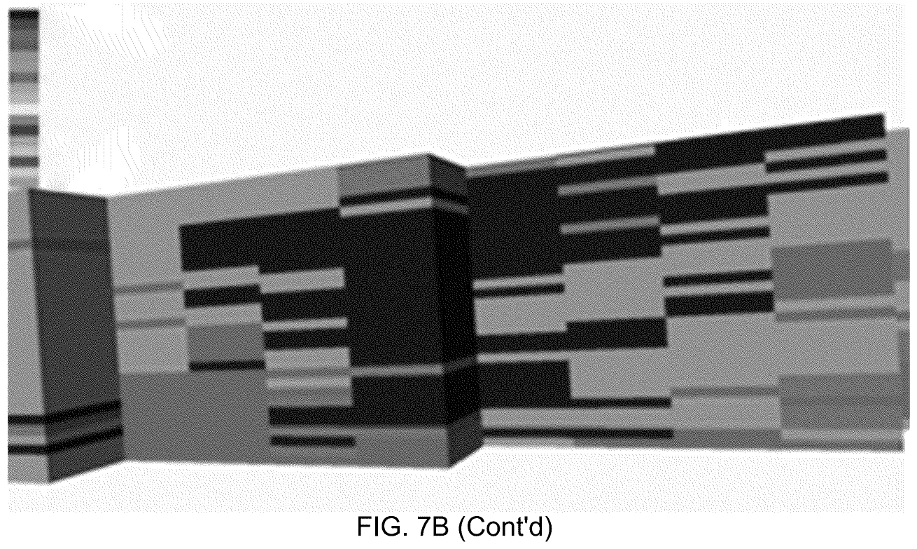

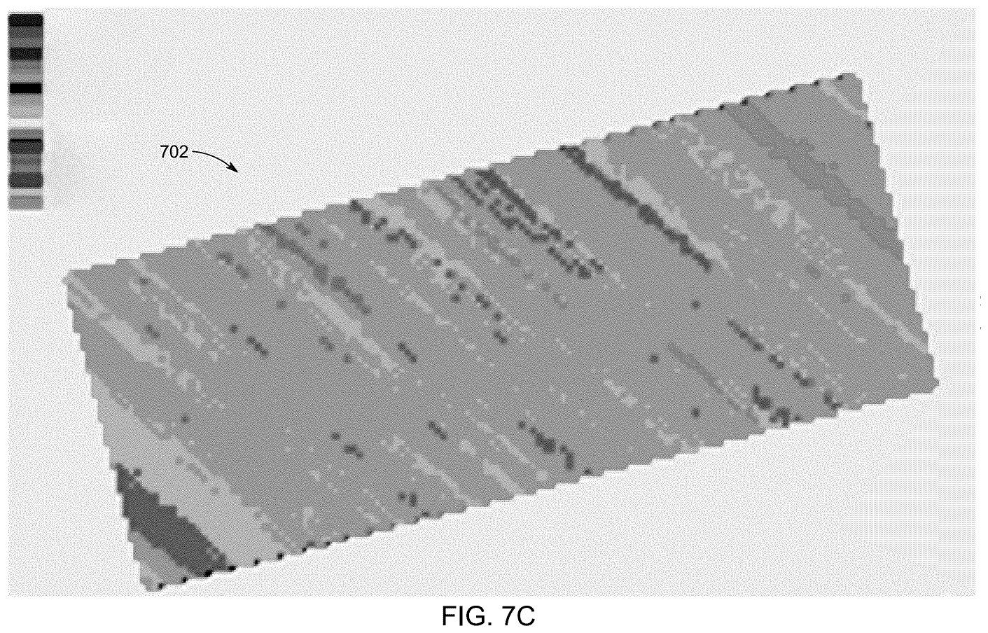

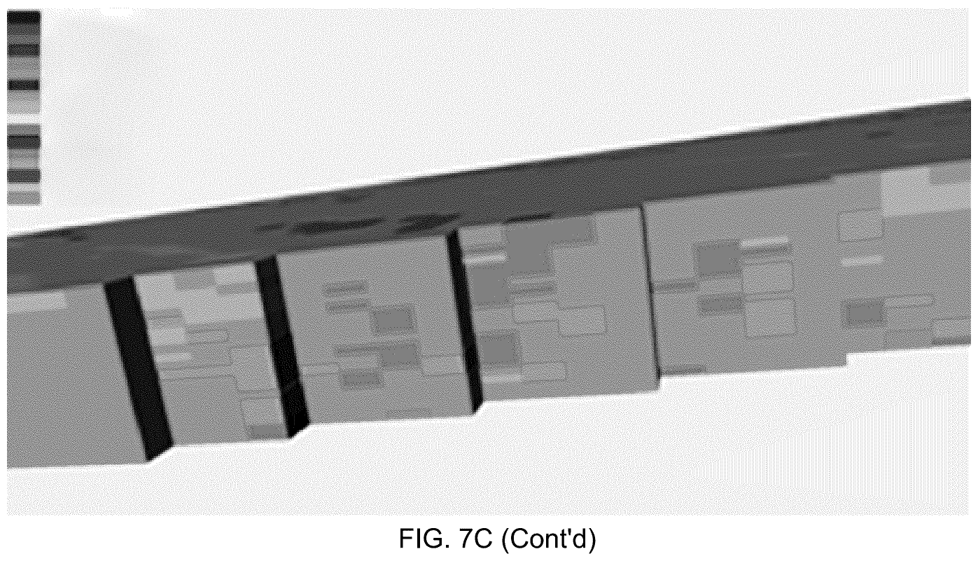

FIG. 7A-FIG. 7C depict a 3D geocellular model 702 of the Upper Khartam Member. The 3D geocellular model 702 shows an overall correlation with the depositional pattern of the Upper Khartam carbonates. As shown in FIG. 7B and FIG. 7C, the 3D geocellular model 702 is inconsistent with the detailed geological settings. In FIG. 7B, the back-stepping nature of the microfacies types is clear. Also, in FIG. 7B, marlstone, coarse-grained oolitic grainstone, and fine-grained oolitic grainstone of BS 4 reflect a shallowing-upward trend. This nature is also clear in FIG. 7C (cross-section of the same bed-set). Similarly, the bioelastic grainstone/packstone, peloidal grainstone/packstone, and the mudstone show similar characteristics.

Nine intra-reservoir bodies were logged laterally for porosity and permeability. The examined bodies were selected to represent the reservoir geology observed in the studied outcrops, and they include FZ-B12B, FZ-B14C, FZ-B15B, FZ-B20B, FZ-B9B, FZ-B10A, FZ-B11C, FZ-B12C, and FZ-B13C of Adam et al. (2018). The closely spaced sampling interval (for example, 5 meters) provided essential data and allowed small-scale (i.e., inter-well) variability patterns of porosity and permeability to be captured. Similarly, upscaled porosity and permeability at the bed-set level show a sort of data preservation, while evident distortion was observed at the high-frequency sequence level.

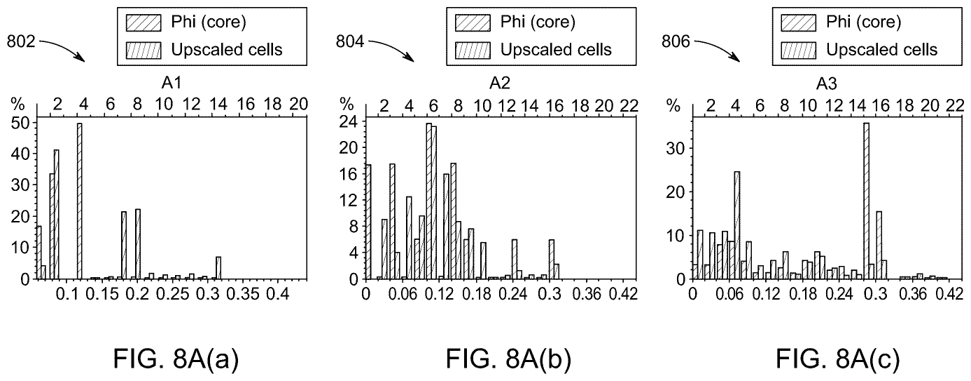

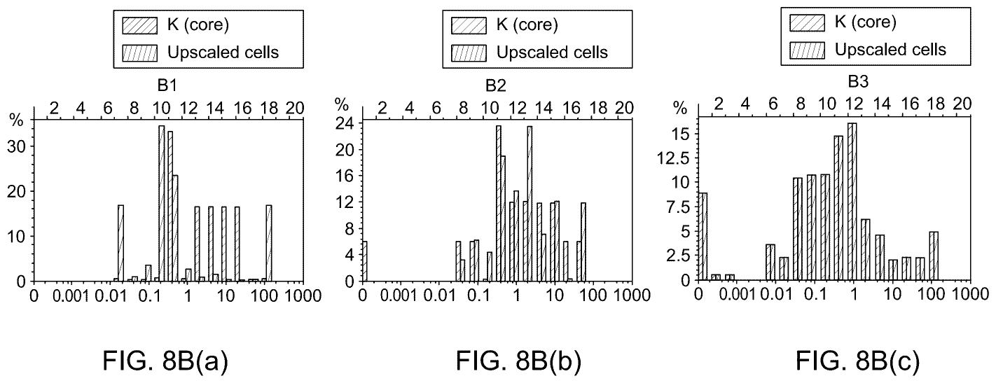

FIGS. 8A(a-c) and FIGS. 8B(a-c) depict histograms showing the comparison between measured and upscaled porosity and permeability. In particular, FIG. 8A(a) shows an example 802 of measured and upscaled porosity at high-frequency sequence level. FIG. 8A(b) shows an example 804 of measured and upscaled porosity at bed-set level. FIG. 8A(c) shows an example 806 of measured and upscaled porosity at bed level. FIG. 8B(a) shows an example 808 of measured and upscaled permeability at high-frequency sequence level. FIG. 8B(b) shows an example 810 of measured and upscaled permeability at bed-set level. FIG. 8B(c) shows an example 812 of measured and upscaled permeability at bed level. An apparent distortion is observed in the original porosity and permeability data at the high-frequency sequence level in FIG. 8A(a) and FIG. 8A(b), while upscaled permeability data at the bed-set level (as shown in FIG. 8A(b) and FIG. 8B(b) is to some extent similar to the original data (as shown in FIG. 8A(c) and FIG. 8B(c).

The SGS was used to model the porosity and permeability of the selected intra-reservoir bodies. Spherical model types were used, and the best-fitted variogram models and maps of porosity and permeability indicated a major trend extending in a north-east direction (around 70 degrees). Notably, the porosity models of the intertidal sheets have relatively large lateral continuity in the north-east direction (about 250 meter) when compared with porosity models of the intertidal creek and intertidal channels (which have a lateral continuity of about 150 meter).

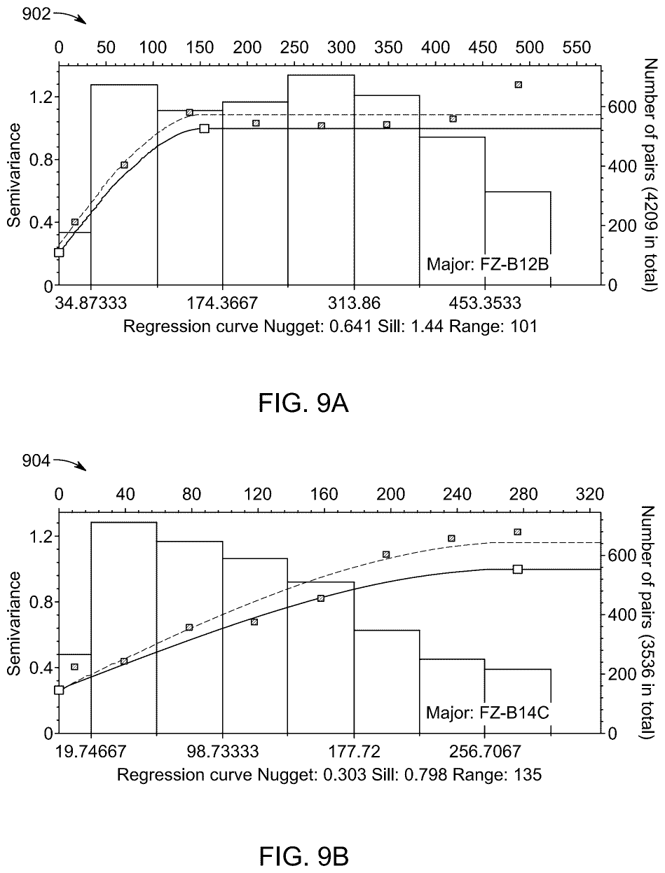

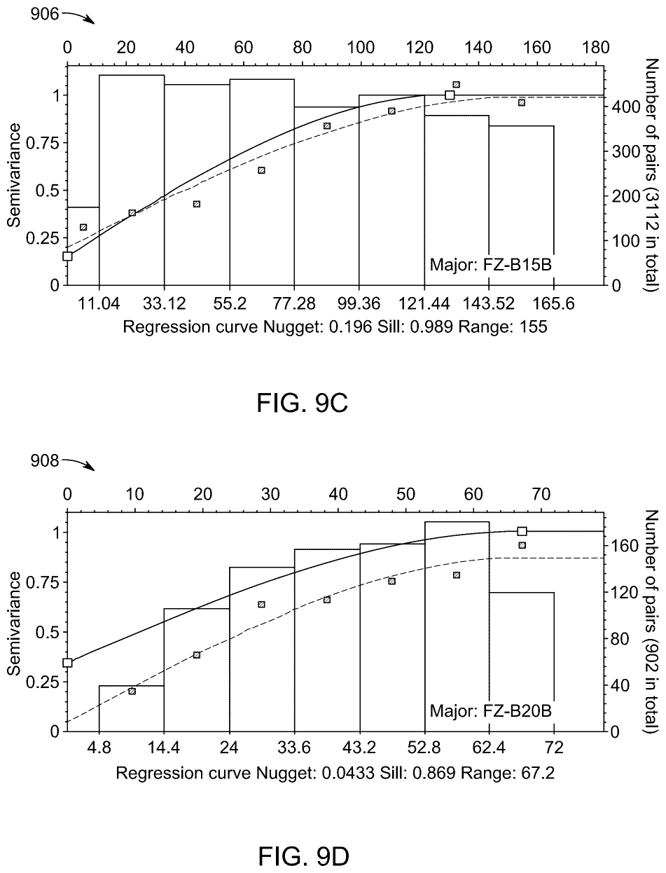

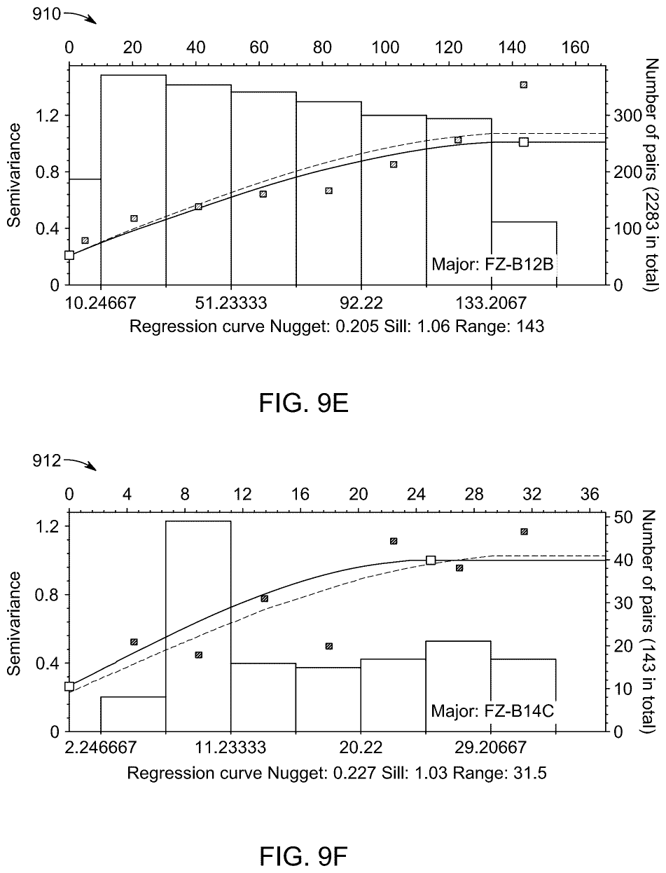

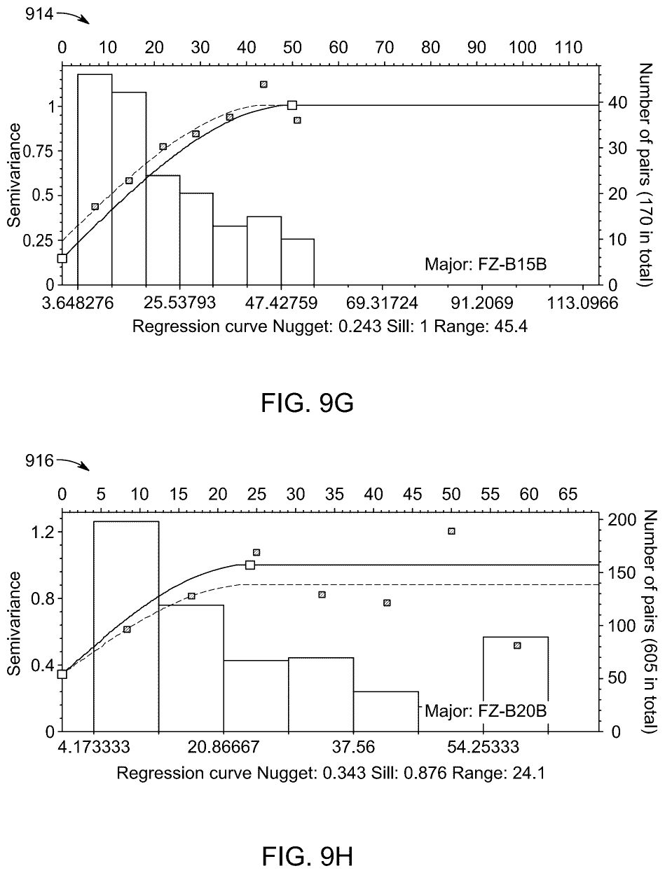

FIG. 9A-FIG. 9H depict porosity variogram models of the studied intra-reservoir bodies. FIG. 9A depicts a representation 902 of major ranges of the studied intra-reservoir unit FZ-B12B. FIG. 9B depicts a representation 904 of major ranges of the studied intra-reservoir unit FZ-B14C. FIG. 9C depicts a representation 906 of major ranges of the studied intra-reservoir unit FZ-B15B. FIG. 9D depicts a representation 908 of major ranges of the studied intra-reservoir unit FZ-B20B. FIG. 9E depicts a representation 910 of minor ranges of the studied intra-reservoir unit FZ-B12B. FIG. 9F depicts a representation 912 of minor ranges of the studied intra-reservoir unit FZ-B14C. FIG. 9G depicts a representation 914 of minor ranges of the studied intra-reservoir unit FZ-B15B. FIG. 9H depicts a representation 916 of minor ranges of the studied intra-reservoir unit FZ-B20B.

The porosity models of the intertidal sheets as shown in FIG. 9B have relatively better lateral continuity in north-east direction (about 250 meters) when compared with the porosity models of the intertidal creek and intertidal channels (as shown in FIG. 9A and FIG. 9C which is about 150 meter). Further, minor range varies around 50 meters.

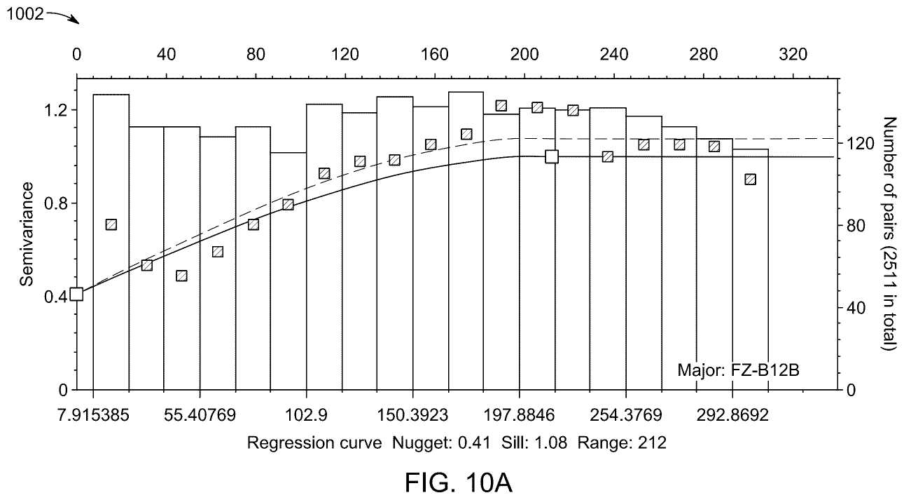

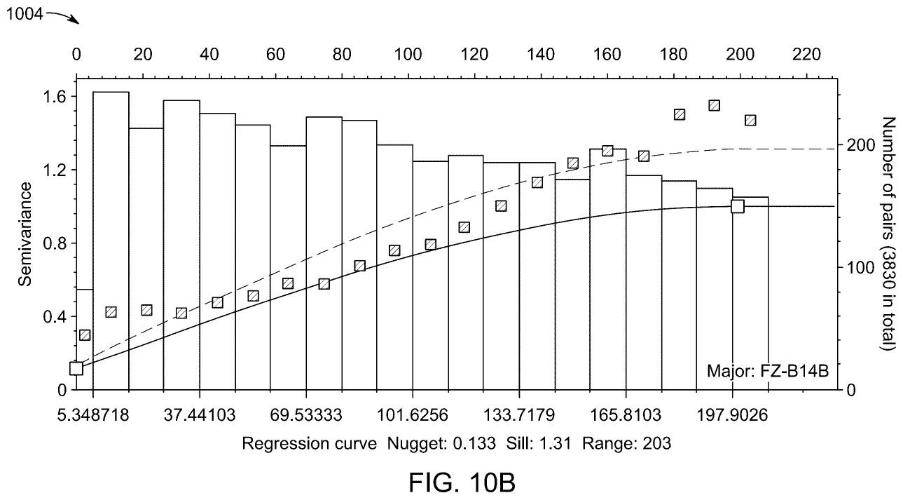

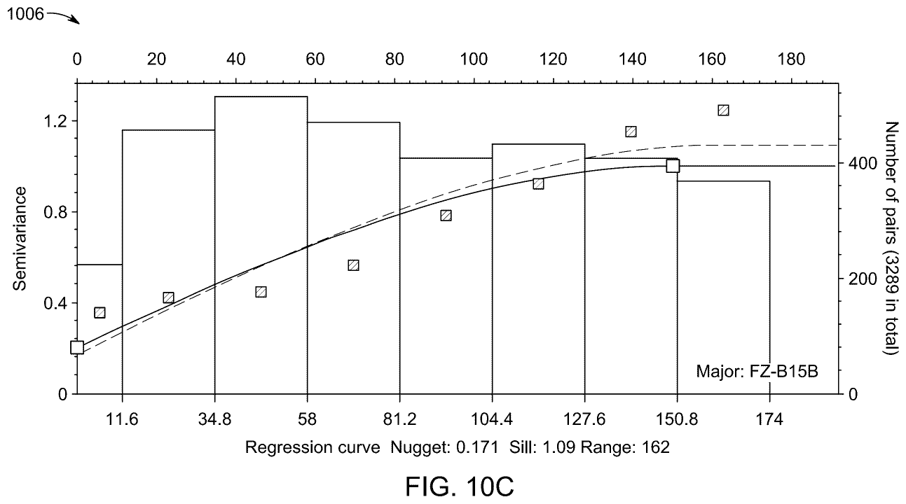

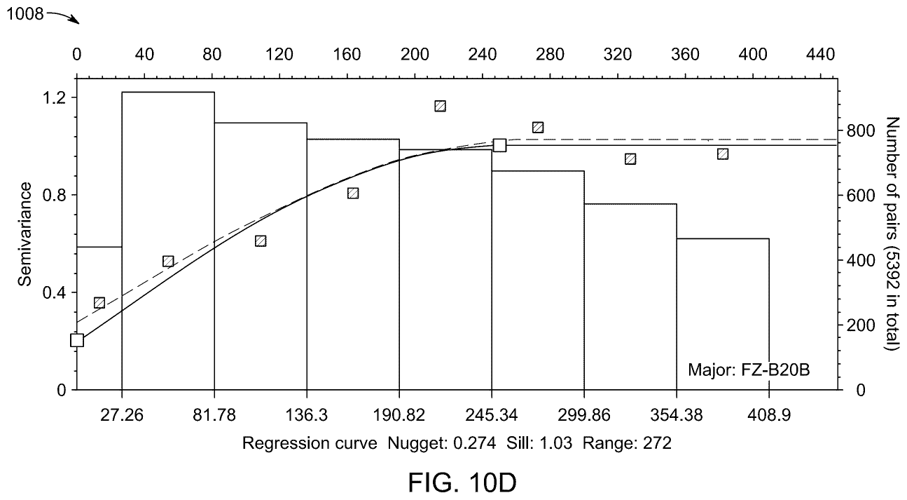

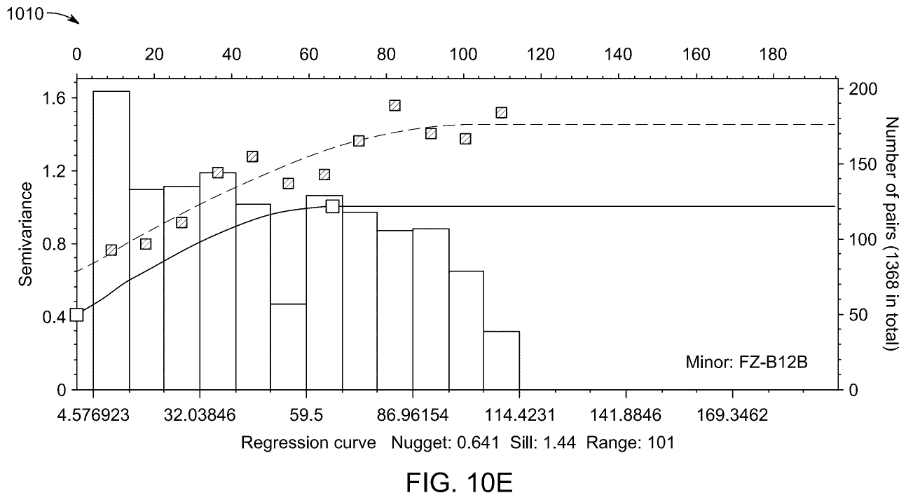

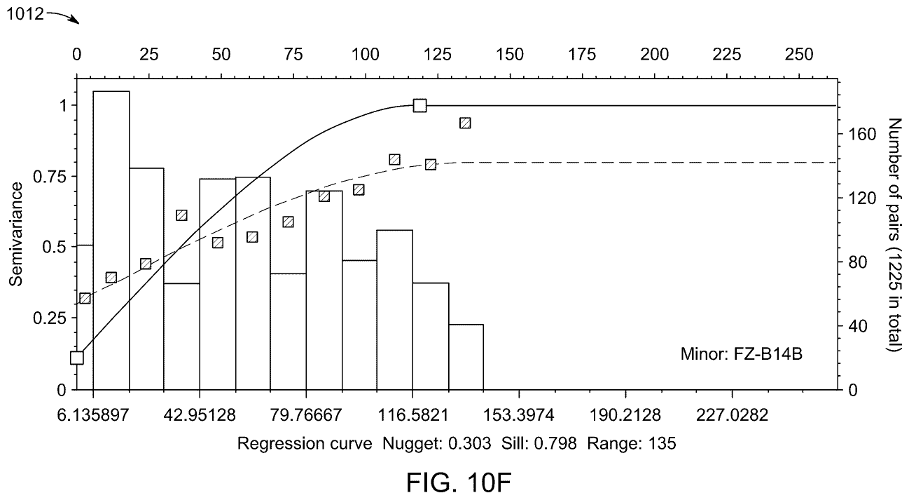

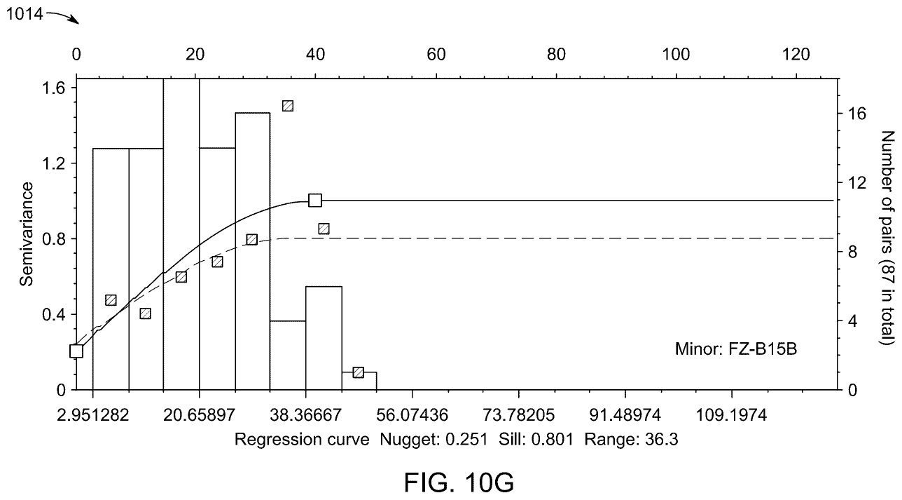

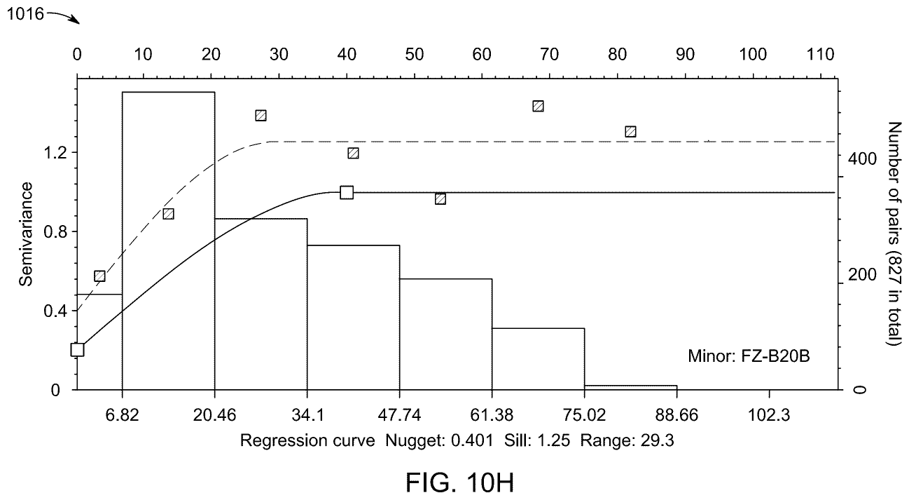

FIG. 10A-FIG. 10H depict permeability variogram models of the studied intra-reservoir bodies. FIG. 10A depicts a representation 1002 of major ranges of the studied intra-reservoir unit FZ-B12B. FIG. 10B depicts a representation 1004 of major ranges of the studied intra-reservoir unit FZ-B14C. FIG. 10C depicts a representation 1006 of major ranges of the studied intra-reservoir unit FZ-B15B. FIG. 10D depicts a representation 1008 of major ranges of the studied intra-reservoir unit FZ-B20B. FIG. 10E depicts a representation 1010 of minor ranges of the studied intra-reservoir unit FZ-B12B. FIG. 10F depicts a representation 1012 of minor ranges of the studied intra-reservoir unit FZ-B14C. FIG. 10G depicts a representation 1014 of minor ranges of the studied intra-reservoir unit FZ-B15B. FIG. 10H depicts a representation 1016 of minor ranges of the studied intra-reservoir unit FZ-B20B. The permeability models show almost the same range for different reservoir architectures and geometries. Generally, the minor ranges of the petrophysical properties occur in the north-west direction (about 330 degrees). As can be observed, different geobodies have almost similar major and minor ranges.

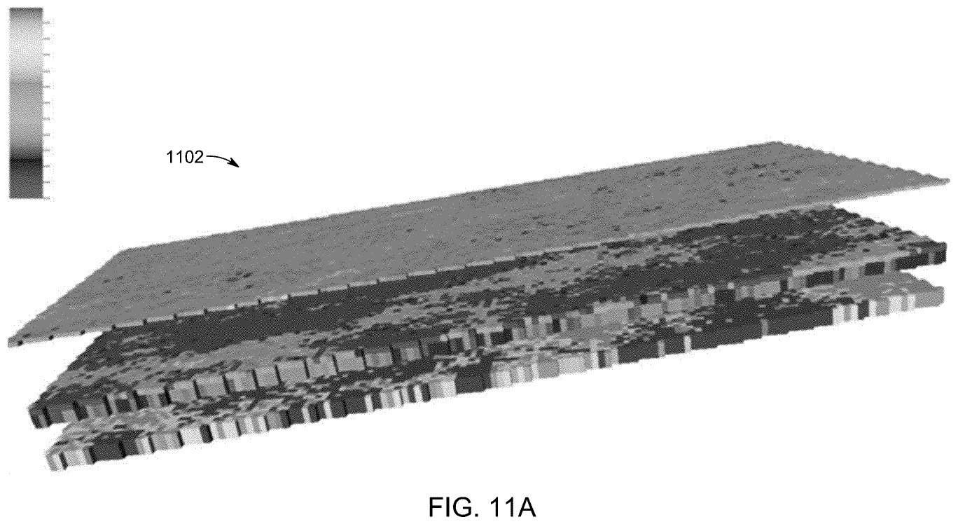

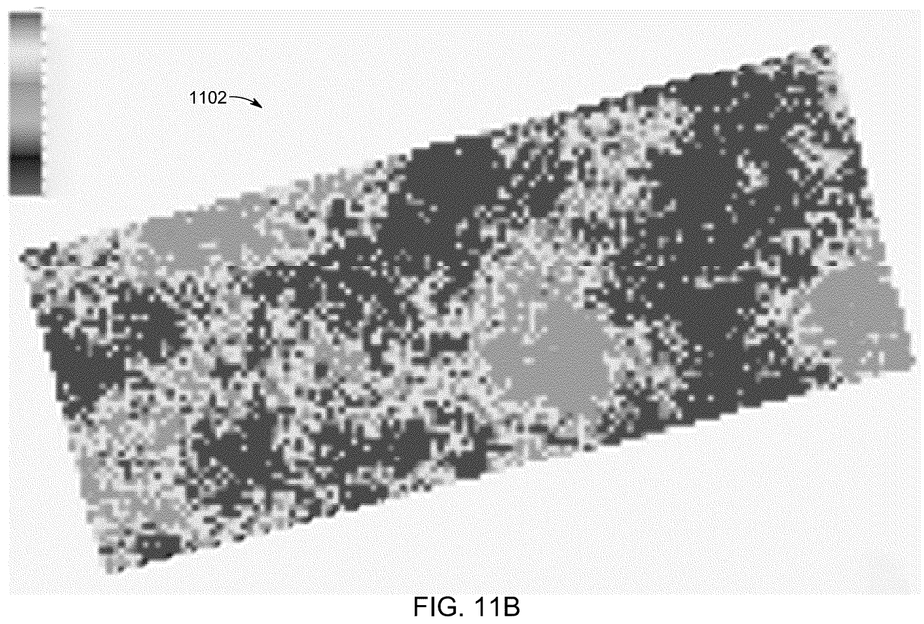

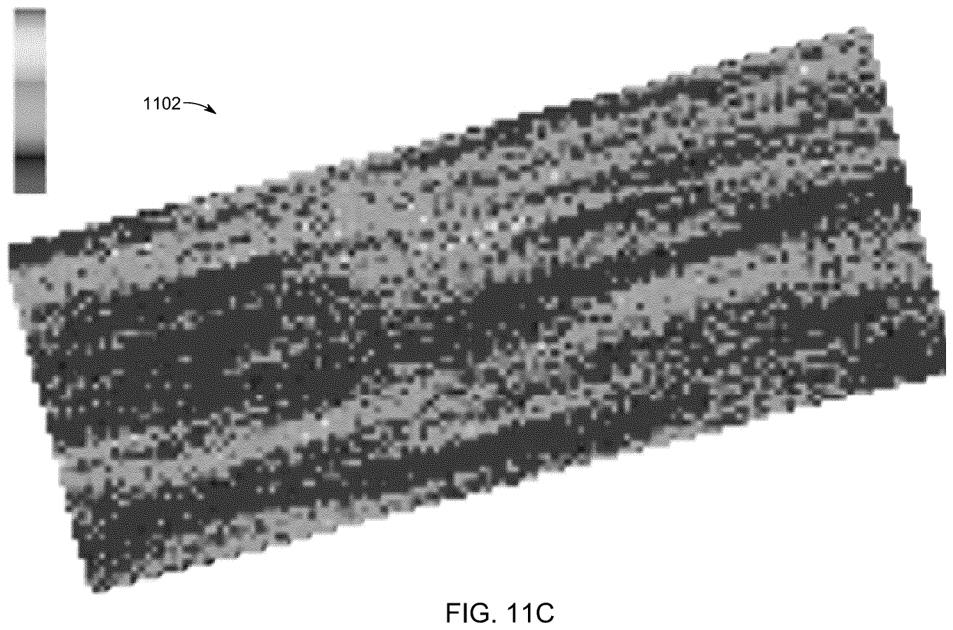

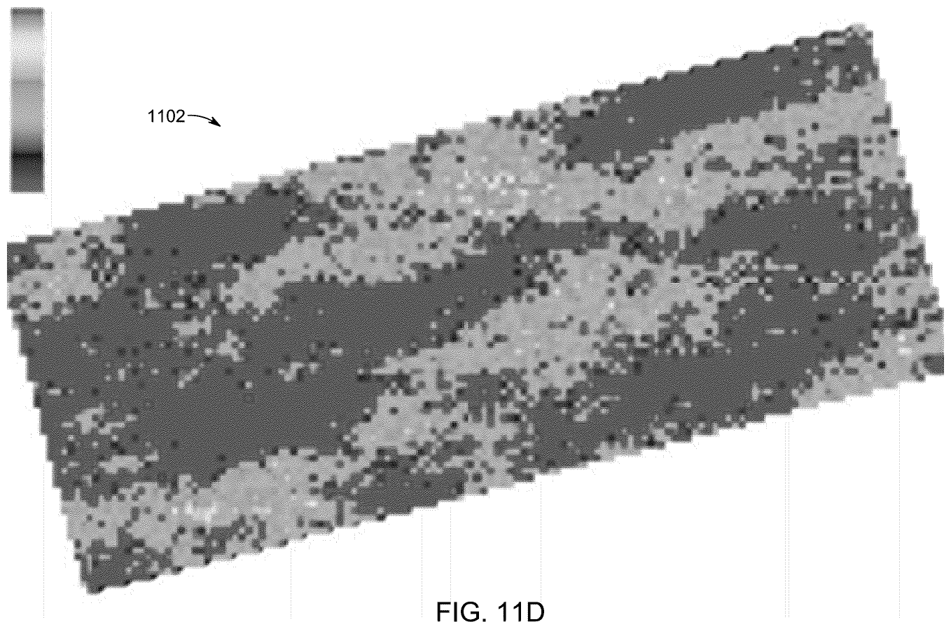

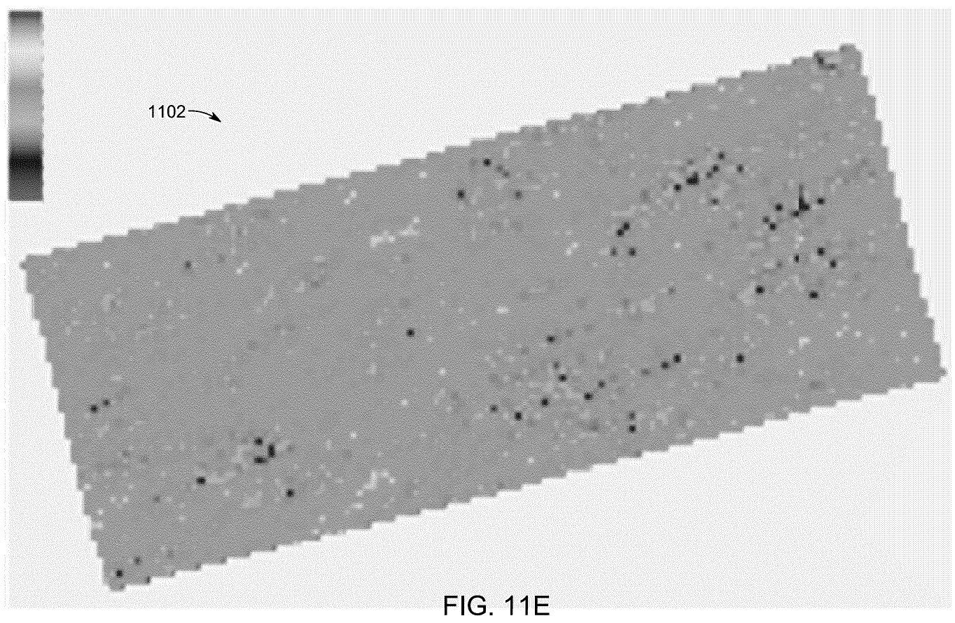

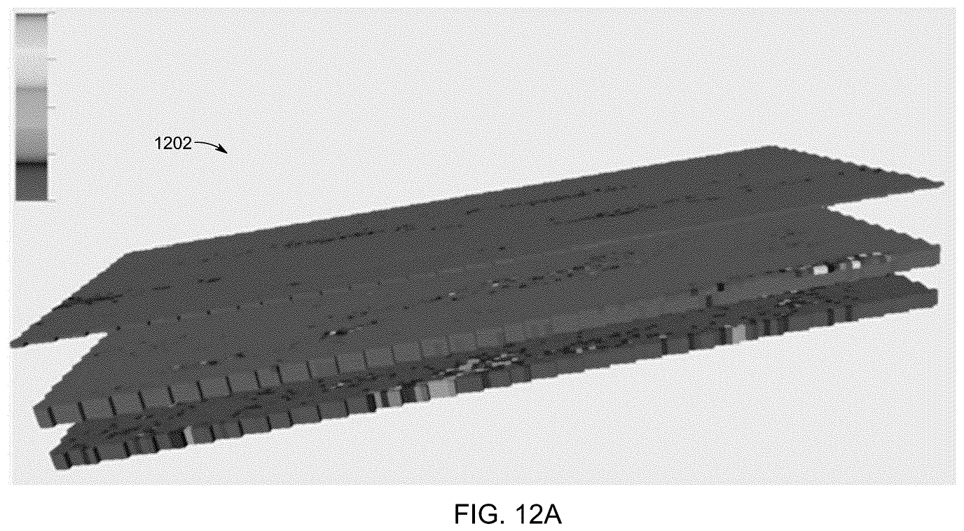

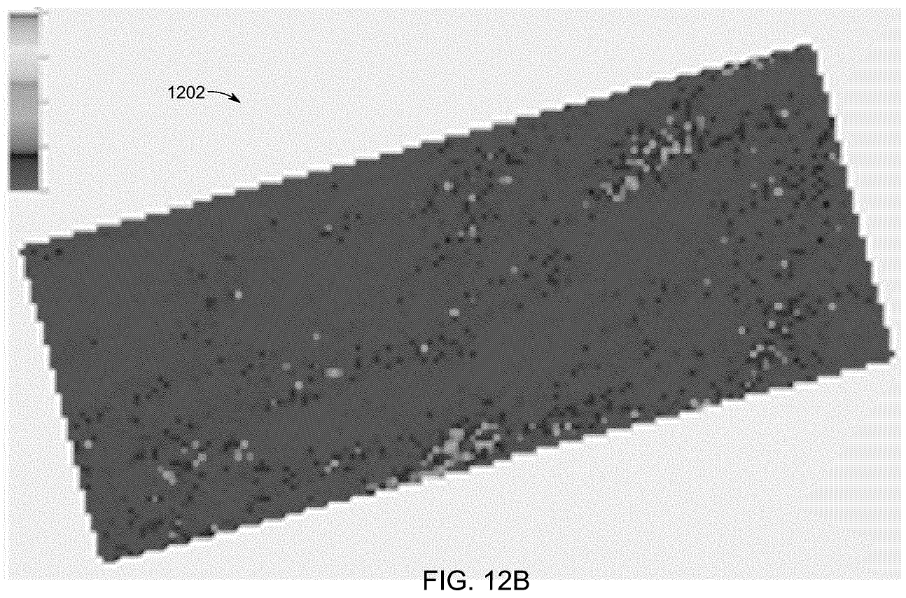

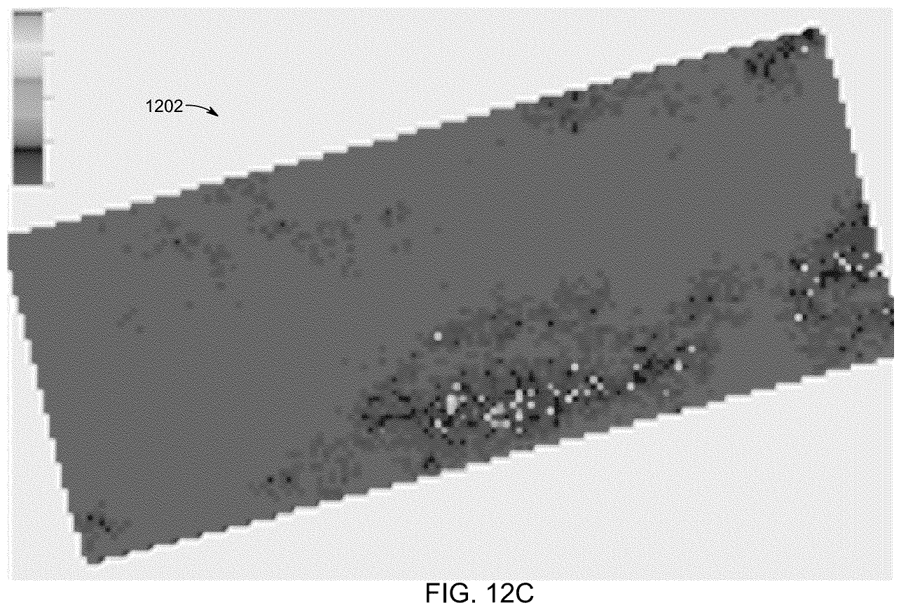

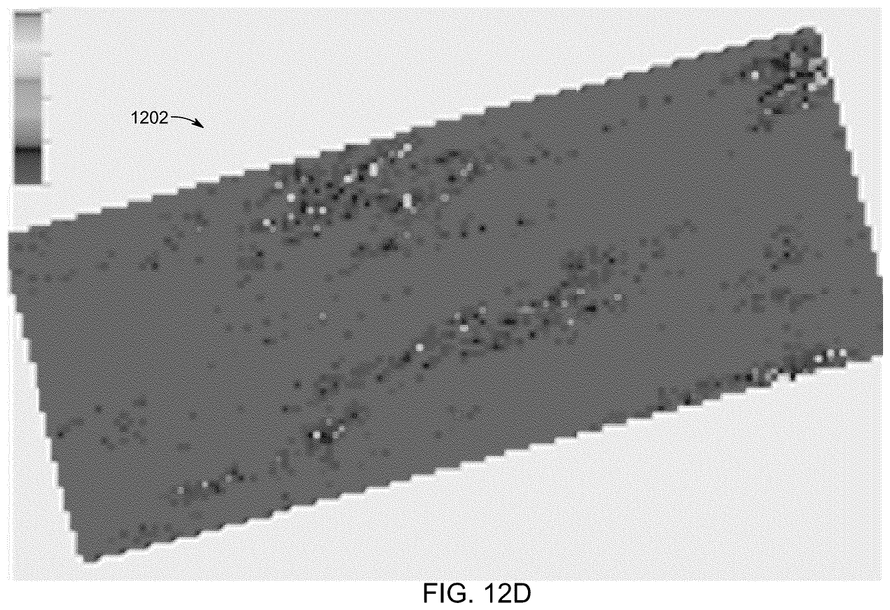

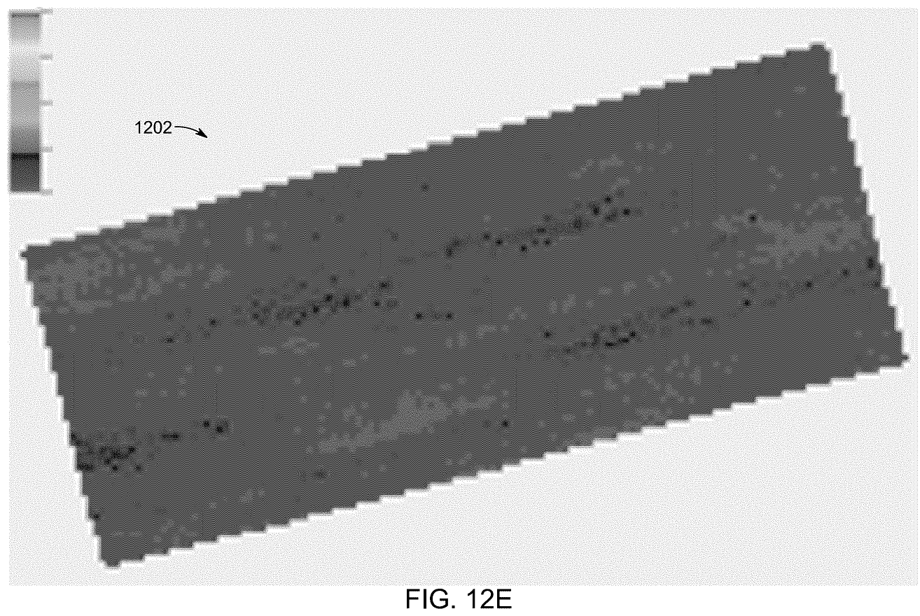

FIG. 11A-FIG. 11E depict a representation 1102 of a 3D geocellular model of porosity and FIG. 12A-FIG. 12E depict a representation 1202 of a 3D geocellular model of permeability.

The extracted numerical data of the variogram models for the studied intra-reservoir bodies are described in Table 4 provided below.

TABLE 4
Variograms parameters of the studied flow units

| | | FZ-B12B | FZ-B14C | FZ-B15B | FZ-B20B |
|---|---|---|---|---|---|
| | | (intertidal | (intertidal | (intertidal | (intertidal |
| Property | Parameter | channels) | sheets) | channels) | sheets) |
| Porosity | Major direction | 74 | 75 | 76 | 66 |
| | Minor direction | 344 | 345 | 346 | 336 |
| | Dip | 0 | 0 | 0 | 0 |
| | Type | Spherical | Spherical | Spherical | Spherical |
| | Sill | 1 | 1 | 1 | 1 |
| | Nugget | 0.205 | 0.264 | 0.147 | 0.343 |
| | Major range | 155 | 276.5 | 130 | 67.2 |
| | Minor range | 143.5 | 25 | 50 | 24.1 |
| | Vertical range | 100 | 100 | 100 | 100 |
| Permeability | Major direction | 66 | 66 | 68 | 77 |
| | Minor direction | 336 | 336 | 338 | 347 |
| | Dip | 0 | 0 | 0 | 0 |
| | Type | Spherical | Spherical | Spherical | Spherical |
| | Sill | 1 | 1 | 1 | 1 |
| | Nugget | 0.41 | 0.11 | 0.2 | 0.2 |
| | Major range | 212.1 | 199.4 | 150 | 250 |
| | Minor range | 66.1 | 119 | 40 | 40 |
| | Vertical range | 100 | 100 | 100 | 100 |

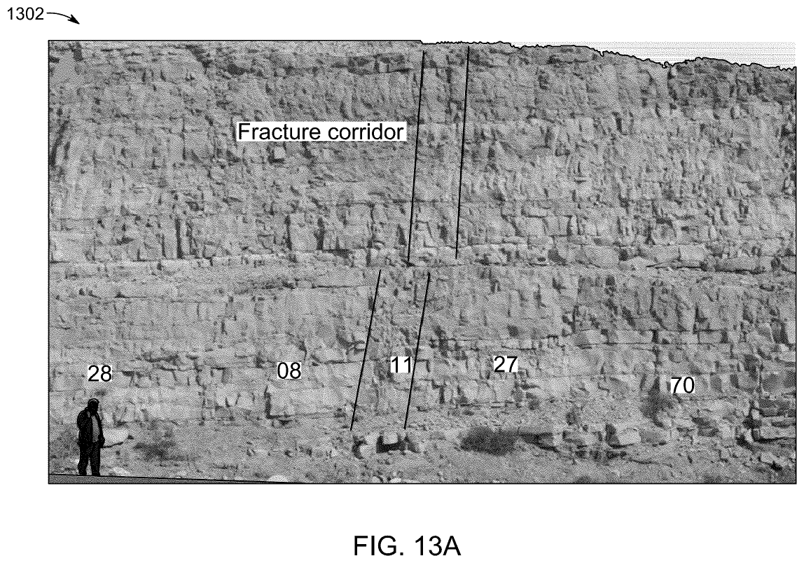

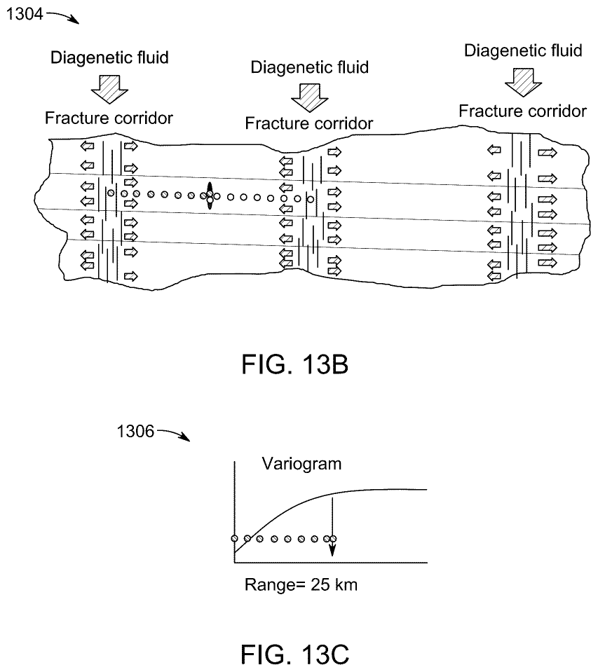

FIG. 13A depicts a representation 1302 of fracture corridors. FIG. 13B depicts a representation 1304 of controlled influxes of diagenetic fluid. FIG. 13C depicts a representation 1306 of controlled influxes of diagenetic fluid that are reflected in the variability patterns in variogram.

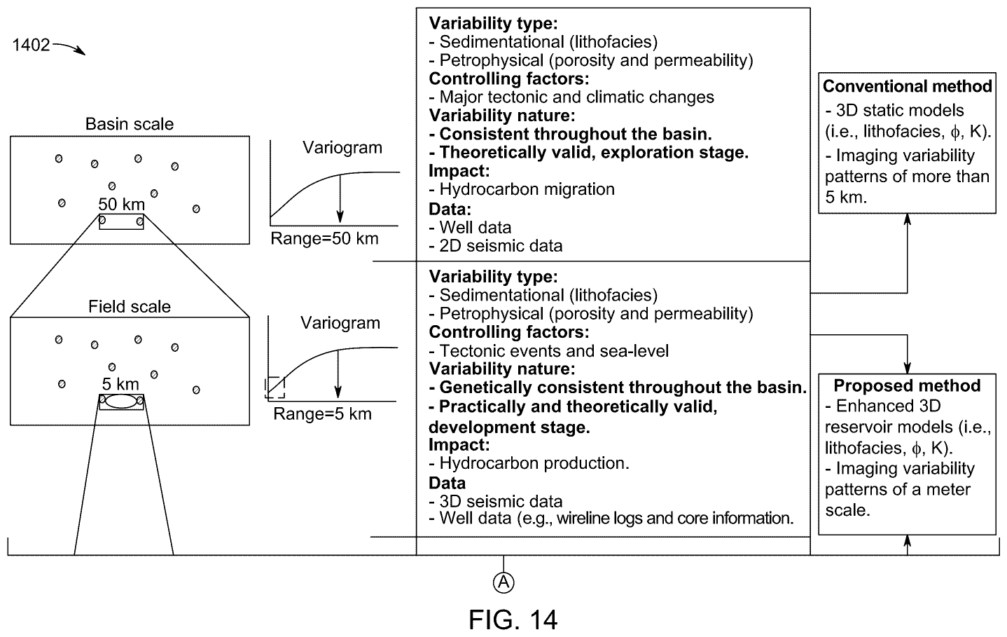

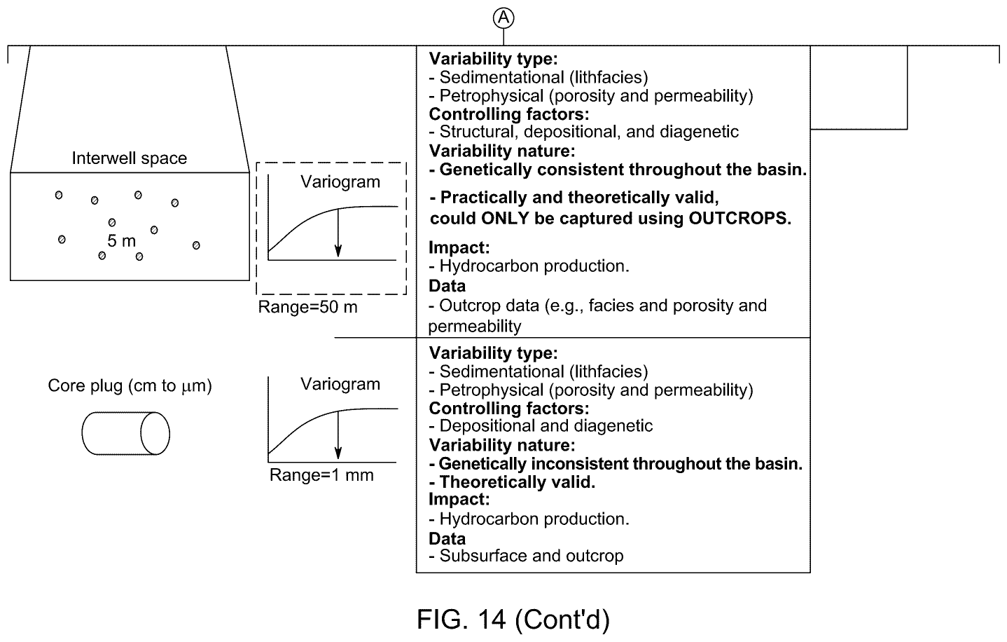

FIG. 14 depicts a representation 1402 of data resolution, scale of variabilities and controlling factors, and information on the present disclosure to enhance 3D reservoir models.

Recently published reservoir data (e.g., microfacies, diagenetic overprints, and porosity types) of the Khuff reservoir from the Kish filed, Zagros Basin, and the Khuff outcrops from central Saudi Arabia (Adam et al., 2018) indicated a noticeable similarity in reservoir characteristics (e.g., diagenetic overprint and porosity types). Accordingly, and based on these data, the Khuff carbonates of central Saudi Arabia may provide a unique and thorough opportunity to understand and predict the Khuff reservoir quality, heterogeneity, and variability trends in the subsurface. Therefore, the results of the present disclosure (i.e., the microfacies and petrophysical models and parameters) can be used when building 3D geological models of the Khuff reservoir (i.e., geobody architecture, microfacies distributions, porosity, and permeability). Importantly, specific modules should be designed to directly integrate outcrop data to recover the stratigraphic patterns of the Khuff reservoirs. These modules can deterministically allow importing the quantitative and qualitative data such as depositional trends, dip and strike, bed thicknesses and extensions, microfacies types, and stratal stacking patterns. The modules may be designed to import the small-scale variability in porosity and permeability (i.e., variograms). Such an approach allows capturing trends of variations beyond the inter-well spacing. This will lead to improved fluid flow simulations and better assessment of the Khuff reservoirs. The optimal exploitation of hydrocarbon reservoirs mainly depends on the numerical integration of small-scale reservoir properties (i.e., geobody, porosity, and permeability). Subsurface data has a coverage limitation related to seismic resolution and interwell spacing. In turn, outcrops provide unique opportunities to examine wide ranges of reservoir properties at a scale beyond interwell spacing. Outcrops of platform carbonates are often in a genetic relationship with subsurface reservoirs. These genetic contexts include i.e., stratigraphic framework, sedimentation processes and products, and patterns of alterations. Therefore, the present disclosure allows for accommodating qualitative and quantitative data obtained from the detailed geological studies of outcrops. Integrated outcrop-based 3D geological models can be a solution for real fluid flow simulation and hence optimal exploitation of hydrocarbon reservoirs.

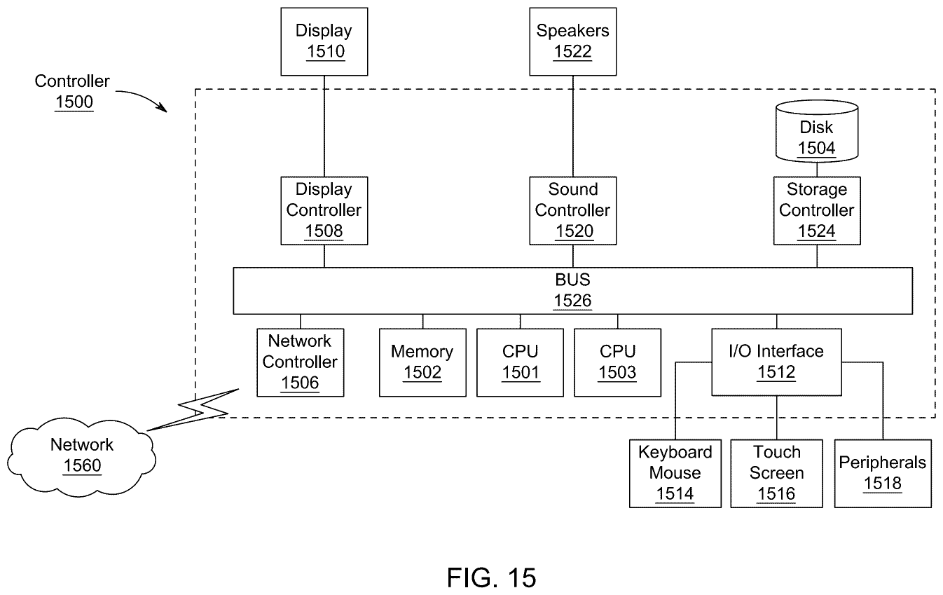

FIG. 15 is an illustration of a non-limiting example of details of computing hardware used in the computing system.

Next, further details of the hardware description of the computing environment according to exemplary embodiments is described with reference to FIG. 15. FIG. 15 is an illustration of a non-limiting example of details of computing hardware used in the computing system, according to exemplary aspects of the present disclosure. In FIG. 15, a controller 1500 is described which is a computing device and includes a CPU 1501 which performs the processes described above/below. The process data and instructions may be stored in memory 1502. These processes and instructions may also be stored on a storage medium disk 1504 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1501, 1503 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1501 or CPU 1503 may be a Xenon or Core processor from Intel of America or an Opteron processor from AMD of America, or may be other processor types that would be recognized by one of ordinary skill in the art. Alternatively, the CPU 1501, 1503 may be implemented on an FPGA, ASIC, PLD or using discrete logic circuits, as one of ordinary skill in the art would recognize. Further, CPU 1501, 1503 may be implemented as multiple processors cooperatively working in parallel to perform the instructions of the inventive processes described above.

The computing device in FIG. 15 also includes a network controller 1506, such as an Intel Ethernet PRO network interface card from Intel Corporation of America, for interfacing with network 1560. As can be appreciated, the network 1560 can be a public network, such as the Internet, or a private network such as an LAN or WAN network, or any combination thereof and can also include PSTN or ISDN sub-networks. The network 1560 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1508, such as a NVIDIA GeForce GTX or Quadro graphics adaptor from NVIDIA Corporation of America for interfacing with display 1510, such as a Hewlett Packard HPL2445w LCD monitor. A general purpose I/O interface 1512 interfaces with a keyboard and/or mouse 1514 as well as a touch screen panel 1516 on or separate from display 1510. General purpose I/O interface also connects to a variety of peripherals 1518 including printers and scanners, such as an OfficeJet or DeskJet from Hewlett Packard.

A sound controller 1520 is also provided in the computing device such as Sound Blaster X-Fi Titanium from Creative, to interface with speakers/microphone 1522 thereby providing sounds and/or music. The general purpose storage controller 1524 connects the storage medium disk 1504 with communication bus 1526, which may be an ISA, EISA, VESA, PCI, or similar, for interconnecting all of the components of the computing device. A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

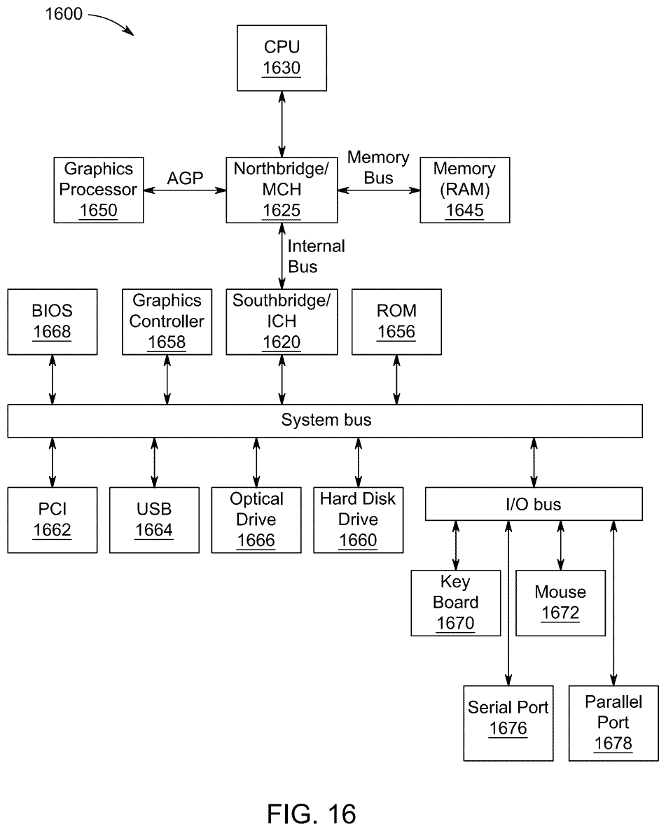

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 16.

FIG. 16 shows a schematic diagram of a data processing system 1600 for performing the functions of the exemplary embodiments. The data processing system 1600 is an example of a computer in which code or instructions implementing the processes of the illustrative embodiments may be located.

In FIG. 16, data processing system 1600 employs a hub architecture including a north bridge and memory controller hub (NB/MCH) 1625 and a south bridge and input/output (I/O) controller hub (SB/ICH) 1620. The central processing unit (CPU) 1630 is connected to NB/MCH 1625. The NB/MCH 1625 also connects to the memory 1645 via a memory bus, and connects to the graphics processor 1650 via an accelerated graphics port (AGP). The NB/MCH 1625 also connects to the SB/ICH 1620 via an internal bus (e.g., a unified media interface or a direct media interface). The CPU Processing unit 1630 may contain one or more processors and even may be implemented using one or more heterogeneous processor systems.

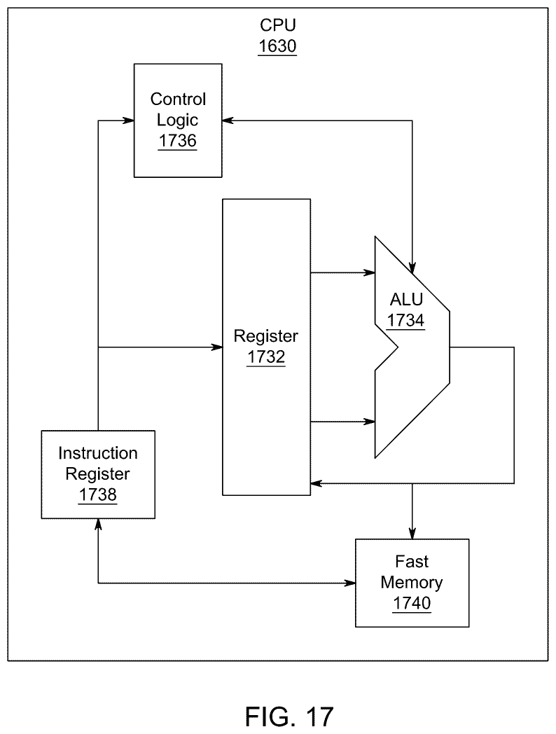

For example, FIG. 17 shows one implementation of CPU 1630. In one implementation, the instruction register 1738 retrieves instructions from the fast memory 1740. At least part of these instructions are fetched from the instruction register 1738 by the control logic 1736 and interpreted according to the instruction set architecture of the CPU 1630. Part of the instructions can also be directed to the register 1732. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 1734 that loads values from the register 1732 and performs logical and mathematical operations on the loaded values according to the instructions. The results from these operations can be feedback into the register and/or stored in the fast memory 1740. According to certain implementations, the instruction set architecture of the CPU 1630 can use a reduced instruction set architecture, a complex instruction set architecture, a vector processor architecture, a very large instruction word architecture. Furthermore, the CPU 1630 can be based on the Von Neuman model or the Harvard model. The CPU 1630 can be a digital signal processor, an FPGA, an ASIC, a PLA, a PLD, or a CPLD. Further, the CPU 1630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 17, the data processing system 1600 can include that the SB/ICH 1620 is coupled through a system bus to an I/O Bus, a read only memory (ROM) 1656, universal serial bus (USB) port 1664, a flash binary input/output system (BIOS) 1668, and a graphics controller 1658. PCI/PCIe devices can also be coupled to SB/ICH 1620 through a PCI bus 1662.

The PCI devices may include, for example, Ethernet adapters, add-in cards, and PC cards for notebook computers. The Hard disk drive 1660 and CD-ROM 1656 can use, for example, an integrated drive electronics (IDE) or serial advanced technology attachment (SATA) interface. In one implementation, the I/O bus can include a super I/O (SIO) device.

Further, the hard disk drive (HDD) 1660 and optical drive 1666 can also be coupled to the SB/ICH 1620 through a system bus. In one implementation, a keyboard 1670, a mouse 1672, a parallel port 1678, and a serial port 1676 can be connected to the system bus through the I/O bus. Other peripherals and devices that can be connected to the SB/ICH 1620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

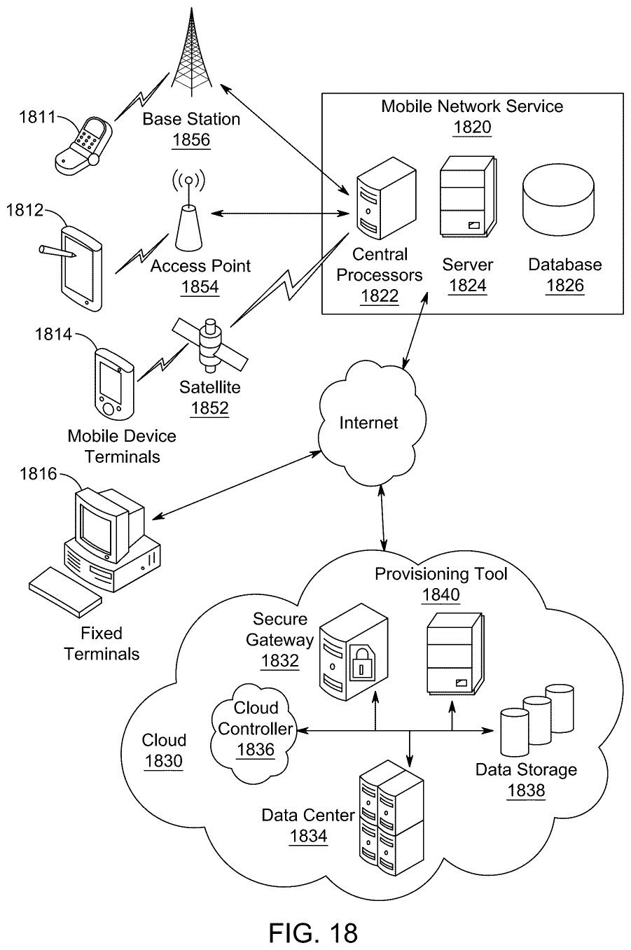

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 18, in addition to various human interface and communication devices (e.g., display monitors, smart phones, tablets, personal digital assistants (PDAs)).

More specifically, FIG. 18 illustrates client devices including a smart phone 1811, a tablet 1812, a mobile device terminal 1814 and fixed terminals 1816. These client devices may be commutatively coupled with a mobile network service 1820 via base station 1856, access point 1854, satellite 1852 or via an internet connection. Mobile network service 1820 may comprise central processors 1822, a server 1824 and a database 1826. Fixed terminals 1816 and mobile network service 1820 may be commutatively coupled via an internet connection to functions in cloud 1830 that may comprise security gateway 1832, data center 1834, cloud controller 1836, data storage 1838 and provisioning tool 1840. The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method to image a subsurface reservoir and resolve intra-reservoir heterogeneities, comprising:
obtaining a plurality of depth logs of porosity and permeability of the subsurface reservoir, wherein the depth logs are laterally spaced about 5 meters, wherein the porosity of each lateral section of a plurality of lateral sections is measured by a helium porosimeter, and the permeability of each lateral section of the plurality of lateral sections is measured using a hassler core holder assembly; and
forming a porosity model and a permeability model of the subsurface reservoir based on the plurality of depth logs of porosity and permeability by applying Sequential Gaussian Simulation (SGS);
identifying one or more heterogeneities in the porosity model and/or the permeability model of the subsurface reservoir; and
forming the image of the subsurface reservoir based on the porosity model and the permeability model.

2. The method of claim 1, further comprising
first obtaining a core sample for each lateral section of the plurality of lateral sections,
forming a flat face at a top face and a bottom face of each core sample,
applying a curable monomer composition to each face of each core sample to seal each face,
wherein the obtaining includes measuring the porosity and permeability of each core sample,
wherein the porosity model and the permeability model include only lateral fluid transmission without axial fluid transmission.

3. The method of claim 1, further comprising
creating a microfacies model by:
assigning values for each microfacies of a plurality of microfacies of each of the lateral sections on a bed level, a bed-set level, a fifth-order sequence level, and a fourth-order sequence level; and
modeling microfacies at the bed-set level with a Sequential Indicator Simulation (SIS) from the assigned values and architectural elements of each of the the lateral sections.

4. The method of claim 1, further comprising
creating a petrophysical model by:
applying the SGS to at least one of the porosity model and the permeability model using a spherical model; and
fitting one or more variogram models and porosity maps using the SGS to the porosity model and/or the permeability model.

5. The method of claim 3, wherein the bed-set layer has a layer thickness between 5 cm and 25 cm.

6. The method of claim 3, wherein the microfacies includes at least seven depositional settings.

7. The method of claim 6, wherein the seven depositional settings include intertidal-subtidal flats, intertidal channels and creeks, shoal ridges, reef complex, outer ramp settings, and supratidal settings.

8. The method of claim 3, wherein the SIS model includes a sheet-like bed that varies in thickness between 5 m to 50 m.

9. The method of claim 3, wherein the SIS model has a lateral extension value between 5 m to 300 m.

10. The method of claim 3, wherein the SIS model has one ore more horizontal variograms that range from 50 m to 1000 m.

11. The method of claim 3, wherein modeling microfacies with the SIS model further comprises dividing the architectural elements of the lateral sections.

12. The method of claim 7, wherein the intertidal channels have a porosity between 300 m and 400 m.

13. The method of claim 7, wherein the intertidal-subtidal flats have a porosity between 100 m and 200 m.

14. The method of claim 1, wherein the porosity model and the permeability model of the subsurface reservoir form a 3D geostatistical model.

15. The method of claim 14, wherein the 3D geostatistical model can accommodate display between 300 to 500 outcrops.

16. The method of claim 14, wherein the 3D geostatistical model includes data to resolve intra-reservoir heterogeneities.

17. A non-transitory computer readable medium having instructions stored therein that, when executed by one or more processors, cause the one or more processors to perform a method including:
obtaining a plurality of depth logs of porosity and permeability of the subsurface reservoir, wherein the depth logs are laterally spaced about 5 meters, wherein the porosity of the lateral sections is measured by a helium porosimeter and the permeability of the lateral sections is measured by a hassler core holder assembly; and
forming a porosity model and a permeability model of the subsurface reservoir based on the plurality of depth logs by applying Sequential Gaussian Simulation (SGS) to the porosity and permeability of the depths logs to identify heterogeneities in the porosity, and a permeability model of the subsurface reservoir.

18. The non-transitory computer readable medium of claim 17, further comprising instructions to create a microfacies model by:
assigning values for each microfacies type of the lateral sections on a bed level, a bed-set level, a fifth-order sequence level, and a fourth-order sequence level; and
modeling microfacies at the bed-set level with a Sequential Indicator Simulation (SIS) from the assigned values and architectural elements of the lateral sections.

19. The non-transitory computer readable medium of claim 17, further comprising instructions to create a petrophysical model by:
applying a SGS to the analyzed porosity and permeability trends through spherical model types; and
fitting variogram models and maps of porosity from the SGS to the analyzed porosity and permeability trends.

20. The non-transitory computer readable medium of claim 17, wherein the porosity model and the permeability model of the subsurface reservoir form a 3D geostatistical model.
